(19) United States
(12) Patent Application Publication
(10) Pub. No.: US 2017/0021385 A1
(43) Pub. Date: Jan. 26, 2017

(54) METHODS OF PREPARING SOLID PARTICLE SOLUTIONS FOR FORMING TEXTURED SURFACES

(71) Applicant: LiquiGlide Inc., Cambridge, MA (US)

(72) Inventors: J. David SMITH, Arlington, MA (US); Tao CONG, Quincy, MA (US); Ravikumar VASUDEVAN, Somerville, MA (US); Hamideh Mohammad ALIPOUR, Cambridge, MA (US); JiaPeng XU, Newton, MA (US); Charles W. HIBBEN, Darien, CT (US); Brian John JORDAN, Winchester, MA (US)

(21) Appl. No.: 15/053,660

(22) Filed: Feb. 25, 2016

Related U.S. Application Data
(60) Provisional application No. 62/120,630, filed on Feb. 25, 2015.

(51) Int. Cl. B05D 1/12; B05D 3/02

(52) U.S. Cl. CPC B05D 1/12; B05D 3/0254; B05D 2320/00

(57) ABSTRACT

Embodiments described herein relate to methods of forming liquid-impregnated surfaces, and in particular to methods of preparing solid particle solutions for forming textured surfaces which can be impregnated with an impregnating liquid to form a liquid-impregnated surface. In some embodiments, a method of forming a textured surface includes dissolving a solid in a solvent to form a solution. The solid has a concentration, which is less than a first saturation concentration of the solid in the solvent at a first temperature and greater than a second saturation concentration of the solid in the solvent at a second temperature. The solution is allowed to form a solid particle solution. The solid particle solution is then disposed on a surface and the solvent is allowed to evaporate to form the textured surface on the surface.

### CROSS-REFERENCE TO RELATED APPLICATIONS

This application claims priority to and the benefit of U.S. Provisional Patent Application Ser. No. 62/120,630, filed Feb. 25, 2015 and titled “Methods of Preparing Solid Particle Solutions for Forming Textured Surfaces,” the disclosure of which is hereby incorporated by reference in its entirety.

### BACKGROUND

Embodiments described herein relate to methods of forming liquid-impregnated surfaces, and in particular to methods of preparing solid particle solutions for forming textured surfaces which can be impregnated with an impregnating liquid to form a liquid-impregnated surface.

The advent of micro/nano-engineered surfaces in the last decade has opened up new techniques for enhancing a wide variety of physical phenomena in thermofluids sciences. For example, the use of micro/nano surface textures has provided non-wetting surfaces capable of achieving less viscous drag, reduced adhesion to ice and other materials, self-cleaning, and water repellency. These improvements result generally from diminished contact (i.e., less wetting) between the solid surfaces and adjacent liquids.

One type of non-wetting surface of interest is a super hydrophobic surface. In general, a super hydrophobic surface includes micro/nano-scale roughness on an intrinsically hydrophobic surface, such as a hydrophobic coating. Super hydrophobic surfaces resist contact with water by virtue of an air-water interface within the micro/nano surface textures.

One of the drawbacks of existing non-wetting surfaces (e.g., superhydrophobic, superoleophobic, and supermetallophobic surfaces) is that they are susceptible to impalement, which destroys the non-wetting capabilities of the surface. Impalement occurs when an impinging liquid (e.g., a liquid droplet or liquid stream) displaces the air entrapped within the surface textures. Previous efforts to prevent impalement have focused on reducing surface texture dimensions from micro-scale to nano-scale.

Another drawback with existing non-wetting surfaces is that they are susceptible to ice formation and adhesion. For example, when frost forms on existing super hydrophobic surfaces, the surfaces become hydrophilic. Under freezing conditions, water droplets can stick to the surface, and ice can accumulate. Removal of the ice can be difficult because the ice may interlock with the textures of the surface. Similarly, when these surfaces are exposed to solutions saturated with salts, for example as in desalination or oil and gas applications, scale builds on the surfaces and results in loss of functionality. Similar limitations of existing non-wetting surfaces include problems with hydrate formation, and formation of other organic or inorganic deposits on the surfaces.

Thus, there is a need for non-wetting surfaces that are more robust. In particular, there is a need for non-wetting surfaces that are more durable and can maintain highly non-wetting characteristics even after repeated use.

### SUMMARY

Embodiments described herein relate to methods of forming liquid-impregnated surfaces, and in particular to methods of preparing solid particle solutions for forming textured surfaces which can be impregnated with an impregnating liquid to form a liquid-impregnated surface. In some embodiments, a method of forming a textured surface includes dissolving a solid in a solvent to form a solution. The solid has a concentration, which is less than a first saturation concentration of the solid in the solvent at a first temperature and greater than a second saturation concentration of the solid in the solvent at a second temperature. The solution is allowed to form a solid particle solution. The solid particle solution is then disposed on a surface and the solvent is allowed to evaporate to form the textured surface on the surface.

### BRIEF DESCRIPTION OF THE DRAWINGS

FIG. 1A is a schematic cross-section view of a product contacting a conventional non-wetting surface, and FIG. 1B shows the conventional non-wetting surface such that the product has impaled the surface.

FIG. 2 is a schematic cross-section of a liquid-impregnated surface according to an embodiment.

FIG. 3 is a schematic process flow diagram of a method of forming a textured surface, according to an embodiment.

FIG. 4 is an image of 75 mL emulsion of rice bran wax and ethanol in a glass container, prepared using an embodiment of the method described herein.

FIG. 5 is an interferometry image of the textured surface formed by spraying solid solution shown in FIG. 4 on an inner surface of the PET bottle.

FIG. 6A is an SEM image of the textured surface of FIG. 5, and FIG. 6B is a higher magnification SEM image of a portion of the textured surface shown in FIG. 6A.

FIG. 7A is an SEM image of a textured surface formed by spraying a solution of silicone wax dissolved in heptane and including a silicone based sealant on a PET surface. FIG. 7B is a higher magnification SEM image of a portion of the textured surface shown in FIG. 7A.

FIG. 8A is an SEM image of a textured surface formed by disposing a solution of a first component of beeswax dissolved in ethanol on a PET surface. FIG. 8B is an SEM image of a textured surface formed by disposing a solution of a second component of beeswax dissolved in ethyl acetate on a PET surface.

FIGS. 9-11 are interferometry images showing particle size distribution of textured surfaces formed on a PET surface by disposing emulsions prepared by dissolving the rice bran wax in ethanol, diisoproyl ether, and isopropyl alcohol, respectively.

FIG. 12 is an interferometry image of a textured surface formed on a PET surface by disposing a water based emulsion of carnauba wax in water and including a sodium chloride additive, on the surface.

FIG. 13 is an interferometry image of a textured surface formed on a PET surface by disposing a first coating of a water based emulsion of carnauba wax in water and including a sodium chloride additive which is allowed to dry, and a second coating of the water based emulsion of carnauba wax in water is then disposed on the first coating.

FIG. 14 is an interferometry image of a textured surface formed on a PET surface having superhydrophobic properties by depositing a solution of isotactic polypropylene in xylene and 2-butanone on a PET surface.

### DETAILED DESCRIPTION

Embodiments described herein relate to methods of forming liquid-impregnated surfaces, and in particular to methods of preparing solid particle solutions for forming textured surfaces which can be impregnated with an impregnating liquid to form a liquid-impregnated surface. Some known surfaces with designed chemistry and roughness, possess substantial non-wetting (hydrophobic) properties, which can be extremely useful in a wide variety of commercial and technological applications. Inspired by nature, these known hydrophobic surfaces include air pockets trapped within the micro or nano texture of the surface which diminishes the contact angle of such hydrophobic surfaces with the liquid, for example, water, an aqueous liquid, or any other aqueous product. As long as these air pockets are stable, the surface maintains non-wetting characteristics. Such known hydrophobic surfaces that include air pockets, however, present certain limitations including, for example: i) the air pockets can be collapsed by external wetting pressures, ii) the air pockets can diffuse away into the surrounding liquid, iii) the surface can lose robustness upon damage to the texture, iv) the air pockets may be displaced by low surface tension liquids unless special texture design is implemented, and v) condensation or frost nuclei, which can form at the nanoscale throughout the texture, can completely transform the wetting properties and render the textured surface highly wetting.

Liquid-impregnated surfaces described herein include impregnating liquids that are impregnated into a surface that includes a matrix of solid features (i.e., a micro-textured surface) defining interstitials regions, such that the interstitial regions include pockets of impregnating liquid. The impregnating liquid is configured to wet the solid surface preferentially and adhere to the micro-textured surface with strong capillary forces, such that the product has an extremely high advancing contact angle and an extremely low roll off angle (e.g., a roll off angle of about 1 degree and a contact angle of greater than about 100 degrees). This enables displacing the product with substantial ease on the liquid-impregnated surface. Therefore, the liquid-impregnated surfaces described herein, provide certain significant advantages over conventional super hydrophobic surfaces including: (i) the liquid-impregnated surfaces have low hysteresis, (ii) the liquid-impregnated surfaces can have self cleaning properties (e.g., reducing or eliminating the length of time needed to rinse a surface clean, or reducing the number of rinsing iterations needed to achieve a given level of cleanliness), (iii) the liquid-impregnated surfaces can withstand high drop impact pressure (i.e., are wear resistant), (iv) the liquid-impregnated surfaces can self heal by capillary wicking upon damage, (v) the liquid-impregnated surfaces exhibit enhanced condensation, (vi) the liquid-impregnated surfaces allow for easier and more accurate observation of graduation markings on a container, (vii) the liquid-impregnated surfaces facilitate an increased evacuation percentage of product-containing containers (i.e., amount of product dispensed when being evacuated), for example reducing the amount of residual product that subsequently enters the recycle/waste stream, and (viii) the liquid-impregnated surfaces facilitate an increased evacuation speed of product-containing containers (e.g., making it possible to use higher viscosities of certain products in applications where it would previously have been infeasible or impractical). Examples of liquid-impregnated surfaces, methods of making liquid-impregnated surfaces and applications thereof, are described in U.S. Pat. No. 8,574,704, entitled “Liquid-Impregnated Surfaces, Methods of Making, and Devices Incorporating the Same,” filed Aug. 16, 2012, and U.S. application Ser. No. 14/084,126 (also referred to as “the '126 application), entitled “Apparatus and Methods for Employing Liquid-Impregnated Surfaces,” filed Nov. 19, 2013, the contents of which are hereby incorporated herein by reference in their entirety. Examples of materials used for forming the solid features on the surface, impregnating liquids, applications involving edible contact liquids, are described in U.S. Pat. No. 8,535,779, entitled “Self-Lubricating Surfaces for Food Packaging and Food Processing Equipment,” filed Jul. 17, 2012, the contents of which are hereby incorporated herein by reference in their entirety. Examples of spray coating methods for spray coating a solid particle solution or suspension on a surface are described in U.S. Publication Ser. No. 14/668,444 (also referred to as “the '444 publication”), filed Mar. 25, 2014, and entitled “Spray Processes and Methods for Forming Liquid-Impregnated Surfaces”, the contents of which are hereby incorporated herein by reference in their entirety. Liquid-impregnated surfaces described herein can, in some embodiments, replace barrier coatings currently used in product containers, while offering added advantages such as those discussed above.

Many different methods can be used to form solid features on a surface, i.e., a textured surface for forming the liquid-impregnated surface. One such method includes spray coating a surface with a solution of solid particles which can precipitate on the surface to form the textured surface. Embodiments described herein include various methods of preparing solid particle solutions that can be spray coated, dip coated, painted, or applied using any other suitable means, on a surface to form a textured surface that can be impregnated with an impregnating liquid to form a liquid-impregnated surface. Embodiments described herein for preparing solid particle solutions provide several advantages including, for example: (1) enable dissolving of solids in a solvent above a saturation concentration of the solid in the solvent at room temperature; (2) various combinations of solids and solvents to obtain optimum adherence of the solid particles to the surface and form a robust textured surface; (3) adding binders to the solution to improve adhesion of the solid particles to the surface; and (4) mixing micro and nanoscale particles in the solution which can serve as nucleating agents for forming the textured surfaces. Any spray coating method can be used to dispose the solution of solid particles on the surface. Examples of such spray coating methods are described in the '444 publication.

In some embodiments, a method of forming a liquid-impregnated surface includes heating a solvent to a first temperature Tₕ. A solid is dissolved in the solvent to form a solution. The solid has a concentration C which is less than the saturation concentration of the solid in the solvent at the first temperature (Cₛₐₜ(Tₕ)) and greater than the saturation concentration of the solid in the solvent at room temperature (Cₛₐₜ(Tᵣ)). The solution is cooled to room temperature to form a solid particle solution, which is disposed on a surface. The solvent is allowed to evaporate from the solid particle solution to form the textured surface. In some embodiments, the method also includes storing the solution at a second temperature greater than room temperature which is sufficient to maintain the solid in at least one of a partially dissolved phase or a completely dissolved phase in the solution. In some embodiments, the method also includes storing the solution at a second temperature at which C<Cₛₐₜ(Tₕ) such that the solid is maintained in a completely dissolved phase in the solution.

In some embodiments, a method of forming a textured surface includes dissolving a solid in a solvent to form a solution. The solid has a concentration, which is less than a first saturation concentration of the solid in the solvent at a first temperature and greater than a second saturation concentration of the solid in the solvent at a second temperature. The solution is allowed to form a solid particle solution. The solid particle solution is then disposed on a surface and the solvent is allowed to evaporate to form the textured surface on the surface.

In some embodiments, the method includes heating the solvent to dissolve the solid in the solvent. In some embodiments, the second temperature is room temperature. In some embodiments, the first temperature is substantially equal to the boiling point of the solvent. In some embodiments, the solid particle solution includes an additive. In some embodiments, the additive is formulated to enhance spreading of the solid particle solution on the surface. In some embodiments, the additive is formulated to enhance wetting of the solid particle solution on the surface. In some embodiments, the additive is formulated to control evaporation of the solvent. In some embodiments, the additive includes a silicone based sealant. In some embodiments, the additive is a surfactant formulated to modify the surface chemistry of the textured surface. In some embodiments, the additive is a surfactant formulated to enhance the wettability of an impregnating liquid to the textured surface. In some embodiments, the additive is formulated to maintain the solid in at least one of a partially or a completely dissolved phase in the solution. In some embodiments, the method further includes adding at least one of micro particles and nanoparticles to the solution to form a suspension. In some embodiments, the method also includes transferring a liquid to the textured surface to form a liquid-impregnated surface.

In some embodiments, a method of forming a textured surface includes combining a solid with a solvent, and dissolving the solid in a solvent to form a solution by heating the solvent to a first temperature. The solid has a concentration, which is less than a first saturation concentration of the solid in the solvent at the first temperature and greater than a second saturation concentration of the solid in the solvent at a second temperature. The solution is allowed to form a solid particle solution by cooling to the second temperature. The solid particle solution is then disposed on a surface and the solvent is allowed to evaporate to form the textured surface on the surface.

In some embodiments, the second temperature is room temperature. In some embodiments, the method includes controlling a cooling rate of the solution. In some embodiments, the solid particle solution includes a plurality of solid particles and the cooling rate is configured to control a particle size distribution of the solid particles in the solvent. In some embodiments, the method further includes heating the surface to evaporate the solvent. In some embodiments, the method also includes transferring a liquid to the textured surface to form a liquid-impregnated surface.

In some embodiments, a method of forming a textured surface includes heating a solvent to a first temperature and then dissolving a solid in the solvent to form a solution. The solid has a concentration, which is less than a first saturation concentration of the solid in the solvent at the first temperature and greater than a second saturation concentration of the solid in the solvent at room temperature. The solution is allowed to cool to the room temperature to form a solid particle solution. The solid particle solution is then disposed on a surface and the solvent is allowed to evaporate to form the textured surface on the surface.

In some embodiments, the method further includes storing the solution at a second temperature greater than room temperature, where the second temperature is sufficient to maintain the solid in at least in one of a partially dissolved phase or a completely dissolved phase in the solution. In some embodiments, the method also includes storing the solution at a second temperature at which the concentration is less than the first saturation concentration such that the solid is maintained in a completely dissolved phase in the solution.

As used herein, the term “about” and “approximately” generally mean plus or minus 10% of the value stated, for example about 250 μm would include 225 μm to 275 μm, approximately 1,000 μm would include 900 μm to 1,100 μm.

As used herein, the term “roll off angle” refers to the inclination angle of a surface at which a drop of a liquid disposed on the surface starts to roll.

As used herein, the term “spray” refers to an atomized spray or mist of a molten solid, a liquid solution, or a solid particle suspension.

As used herein, the term “complexity” is equal to (r−1)×100% where r is the Wenzel roughness.

As used herein, the term “volatile” refers to a liquid having a vapor pressure substantially higher than the vapor pressure of water at room temperature and pressure. Such volatile liquids can evaporate at a substantially faster rate at room temperature and pressure relative to a rate at which water evaporates under the same conditions.

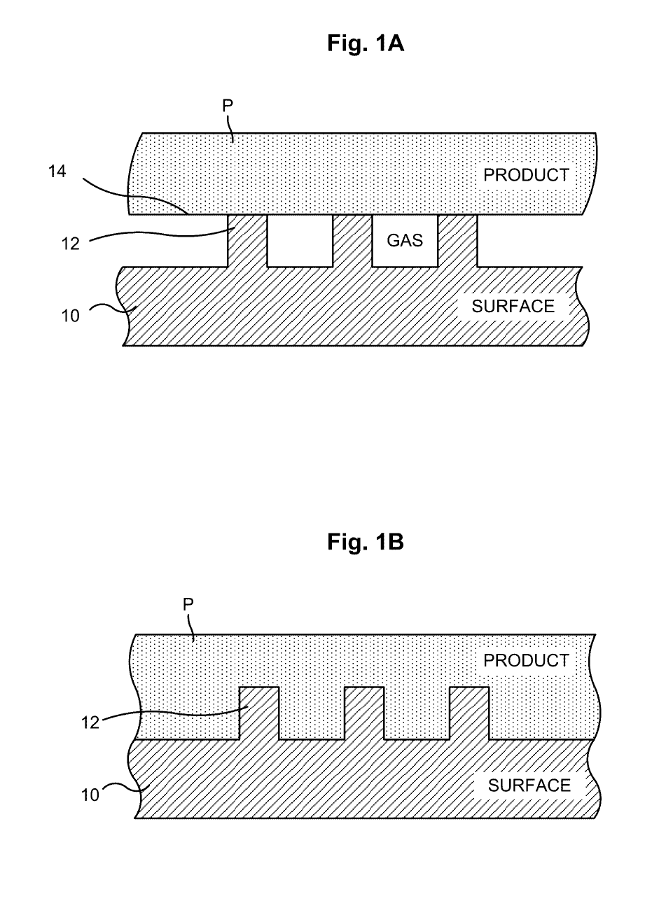

Referring now to FIGS. 1A and 1B, a conventional non-wetting surface 10 is a textured surface such that the non-wetting surface 10 includes a plurality of solid features 12 disposed on the surface 10. The solid features 12 define interstitial regions between each of the plurality of solid features which are impregnated by a gas, for example, air. A product P (e.g., a non-Newtonian fluid, a Bingham fluid, or a thixotropic fluid) is disposed on the conventional non-wetting surface such that the product contacts a top portion of the solid features but a gas-product interface 14 prevents the product from wetting the entire surface 10. In some cases, the product P can displace the impregnating gas and become impaled within the features 12 of the surface 10. Impalement may occur, for example, when a droplet of the product P impinges the surface 10 at high velocity. When impalement occurs, the gas occupying the regions between the solid features 12 is replaced with the product P, either partially or completely, and the surface 10 may lose its non-wetting capabilities.

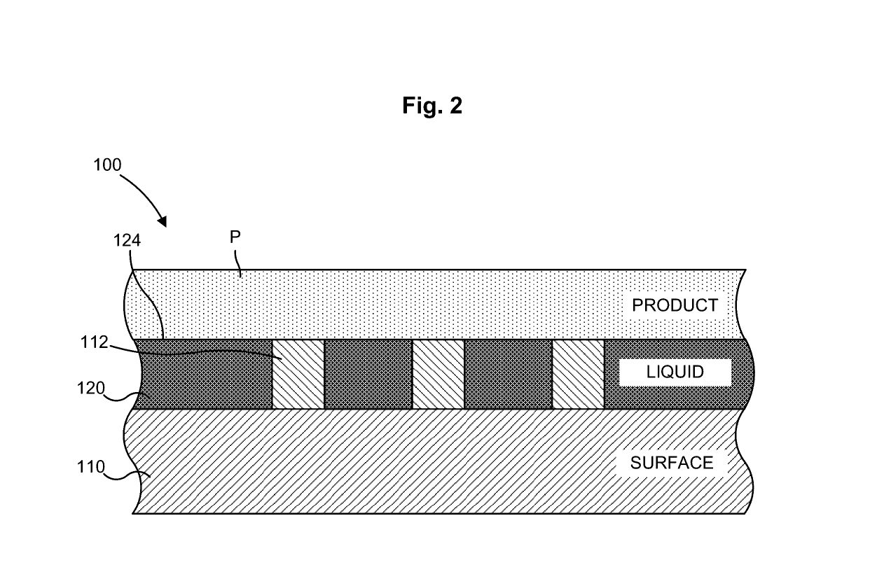

Referring now to FIG. 2, in some embodiments a liquid-impregnated surface 100 includes a solid surface 110 that includes a plurality of solid features 112 disposed on the surface 110 such that the plurality of solid features 112 define interstitial regions between the plurality of solid features. An impregnating liquid 120 is impregnated into the interstitial regions defined by the plurality of solid features 112. A product P is disposed on the liquid-impregnated surface 100 such that a liquid-product interface 124 separates the product from the surface 110 and prevents the product P from entirely wetting the surface 110.

The product P can be any product, for example, a non-Newtonian fluid, a Bingham fluid, a thixotropic fluid, a high viscosity fluid, a high zero shear rate viscosity fluid (shear-thinning fluid), a shear-thickening fluid, and a fluid with high surface tension and can include, for example a food product, a drug, a health and/or beauty product, a viscous industrial fluid, an agrichemical product (e.g., pesticide, insecticide, herbicide, fungicide, nematicide, fertilizer, growth agent, soil conditioner, etc.) any other product described herein or a combination thereof.

The surface 110 can be any surface that has a first roll off angle, for example a roll off angle of a product in contact with the surface 110 (e.g., water, food products, drugs, health or beauty products, or any other products described herein). The surface 110 can be a flat surface, for example, silicon wafer, a glass wafer, a table top, a wall, a wind shield, a ski goggle screen, or can be a contoured surface, for example a container, a propeller, a pipe, etc.

In some embodiments, the surface 110 can include an interior surface of a container for housing the product P (e.g., a food product, an FDA approved drug, and/or a health or beauty product) and can include, for example, tubes, bottles, vials, flasks, molds, jars, tubs, cups, glasses, pitchers, barrels, bins, totes, tanks, kegs, tubs, syringes, tins, pouches, lined boxes, hoses, cylinders, and cans. The container can be a single-use (e.g., retail) container or a container used for the storage of bulk materials. The container can be constructed in almost any desirable shape. In some embodiments, the surface 110 can include an interior surface of hoses, piping, conduit, nozzles, syringe needles, dispensing tips, lids, pumps, and other surfaces for containing, transporting, or dispensing the product P. The surface 110, for example the interior surface of a container can be constructed of any suitable material including plastic, glass, metal, ceramics, coated fibers, and combinations thereof. Suitable surfaces can include, for example, polystyrene (PS), nylon, wax, polyethylene terephthalate (PET/PETE), polypropylene (PP), high-density polyethylene (HDPE), low-density polyethylene (LDPE), polyurethane, polysulphone, polyethersulfone, polyvinyl chloride (PVC), polytetrafluoroethylene (PTFE), tetrafluoroethylene (TFE), polyvinyl alcohol (PVA), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), polychlorotetrafluoroethylene (PCTFE), polyethyleneglycol (PEG), polyfluoropolyether (PFPE), poly(acrylic acid), poly(propylene oxide), acrylonitrile butadiene styrene (ABS), D-sorbitol, Tecnoflon cellulose acetate, fluoroPOSS, and polycarbonate. The container can be constructed of rigid or flexible materials. Foil-lined or polymer-lined cardboard, paper boxes or metal containers can also form suitable containers. In some embodiments, the surface can be solid, smooth, textured, rough, or porous.

The surface 110 can be an inner surface of a container and can have a first roll off angle, for example, a roll off angle of a product CL (for example, laundry detergent, or any other product described herein). The surface 110 can be a flat surface, for example an inner surface of a prismatic container, or a contoured surface, for example an inner surface, of a circular, oblong, elliptical, oval or otherwise contoured container.

A plurality of solid features 112 are disposed on the surface 110, such that the plurality of solid features 112 define interstitial regions between the plurality of solid features 112. In some embodiments, the solid features 112 can be posts, spheres, particles, micro/nano needles, nanograss, pores, cavities, interconnected pores, inter-connected cavities, any other random geometry that provides a micro and/or nano surface roughness. In some embodiments, the height of features can be about 10 μm, 20 μm, 30 μm, 40 μm, 50 μm, 60 μm, 70 μm, 80 μm, 90 μm, or about 100 μm, 200 μm, 300 μm, 400 μm, 500 μm, 600 μm, 700 μm, 800 μm, 900 μm, up to about 1 mm, inclusive of all ranges therebetween, or any other suitable height for receiving the impregnating liquid 120. For example, in some embodiments, the solid features 112 can have a height of about 1 nm, 5 nm, 10 nm, 20 nm, 30 nm 40 nm, 50 nm, 100 nm, 200 nm, 300 nm, 400 nm, 500 nm, 600 nm, 700 nm, 800 nm, 900 nm, or about 1,000 nm, inclusive of all ranges therebetween. In some embodiments, the height of the features can be less than about 1 μm. Furthermore, the height of solid features 112 can be, for example, substantially uniform. In some embodiments, the solid features can have a Wenzel roughness “r” greater than about 1.01, 1.05, 1.1, 1.2, 1.3, 1.4, 1.5, 1.6, 1.7, 1.8, 1.9, 2.0, 2.5, 3, 5, or about 10. In some embodiments, the solid features 112 can have an interstitial spacing, for example, in the range of about 1 μm to about 100 μm, or about 5 nm to about 1 μm. In some embodiments, the textured surface 110 can have hierarchical features, for example, micro-scale features that further include nano-scale features thereupon. In some embodiments, the surface 110 can be isotropic. In some embodiments, the surface 110 can be anisotropic.

In some embodiments, the solid features 112 may be formed of a collection or coating of particles including, but not limited to insoluble fibers (e.g., purified wood cellulose, microcrystalline cellulose, and/or oat bran fiber), wax (e.g., carnauba wax, Japan wax, beeswax, rice bran wax, candelilla wax, fluorinated waxes, waxes containing silicon, waxes of esters of fatty acids, fatty acids, fatty acid alcohols, glycerides, triglycerides, etc.), other polysaccharides, fructo-oligosaccharides, metal oxides, montan wax, lignite and peat, ozokerite, ceresins, bitumens, petrolatuns, paraffins, microcrystalline wax, lanolin, esters of metal or alkali, flour of coconut, almond, potato, wheat, pulp, zein, dextrin, cellulose ethers (e.g., methyl cellulose, ethyl cellulose, propyl cellulose, hydroxyethyl cellulose, hydroxyethyl cellulose, hydroxypropyl cellulose (HPC), hydroxyethyl methyl cellulose, hydroxypropyl methyl cellulose (HPMC), ethyl hydroxyethyl cellulose), ferric oxide, ferrous oxide, silicas, clay minerals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, polycarbonate, fluorinated silicones, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), polychlorotetrafluoroethylene (PCTFE), polyvinyl alcohol (PVA), polyethyleneglycol (PEG), polyfluoropolyether (PFPE), poly(acrylic acid), poly(propylene oxide), D-sorbitol, tecnoflon cellulose acetate, fluoroPOSS, fluoroethylene-alkyl vinyl ether (FEVE), modified polytetrafluoroethylene, fluoropolyurethane, fluoroacrylic, copolymer of tetrafluoroethylene/chlorotrifluoroethylene and vinyl monomer, copolymer of vinylidenefluoride and methyl methacrylate, whey and/or any other edible solid particles described herein or any combination thereof.

In some embodiments, surface energy of the surface 110 and/or the solid features 112 can be modified, for example, to enhance the adhesion of the solid features 112 to the surface 110 or to enhance the affinity of the impregnating liquid 120 to the solid features 112 and/or the surface 110. Such surface modification processes can include, for example, sputter coating, silane treatment, fluoro-polymer treatment, anodization, passivation, chemical vapor deposition, physical vapor deposition, oxygen plasma treatment, electric arc treatment, thermal treatment, any other suitable surface chemistry modification process or combination thereof.

The solid features 112 can include micro-scale features such as, for example posts, spheres, nano-needles, pores, cavities, interconnected pores, grooves, ridges, interconnected cavities, or any other random geometry that provides a micro and/or nano surface roughness. In some embodiments, the solid features 112 can include particles that have micro-scale or nano-scale dimensions which can be randomly or uniformly dispersed on a surface. Characteristic spacing between the solid features 112 can be about 1 mm, about 900 μm, about 800 μm, about 700 μm, about 600 μm, about 500 μm, about 400, μm, about 300 μm, about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, or 100 nm, about 90 nm, about 80 nm, about 70 nm, about 60 nm, about 50 nm, about 40 nm, about 30 nm, about 20 nm, about 10 nm, or about 5 nm. In some embodiments, characteristic spacing between the solid features 112 can be in the range of about 100 μm to about 100 nm, about 30 μm to about 1 μm, or about 10 μm to about 1 μm. In some embodiments, characteristic spacing between solid features 112 can be in the range of about 100 μm to about 80 μm, about 80 μm to about 50 μm, about 50 μm to about 30 μm, about 30 μm to about 10 μm, about 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 5 nm, inclusive of all ranges therebetween.

In some embodiments, the solid features 112, for example solid particles can have an average dimension of about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, about 100 nm, about 90 nm, about 80 nm, about 70 nm, about 60 nm, about 50 nm, about 40 nm, about 30 nm, about 20 nm, about 10 nm, or about 5 nm. In some embodiments, the average dimension of the solid features 112 can be in the range of about 100 μm to about 100 nm, about 30 μm to about 10 μm, or about 20 μm to about 1 μm. In some embodiments, the average dimension of the solid feature 112 can be in the range of about 100 μm to about 80 μm, about 80 μm to about 50 μm, about 50 μm to about 30 μm, or about 30 μm to about 10 μm, or 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 5 nm, inclusive of all ranges therebetween. In some embodiments, the height of the solid features 112 can be substantially uniform. In some embodiments, the surface 110 can have hierarchical features, for example micro-scale features that further include nano-scale features disposed thereupon.

In some embodiments, the solid features 112 (e.g., particles) can be porous. Characteristic pore size (e.g., pore widths or lengths) of particles can be about 5,000 nm, about 3,000 nm, about 2,000 nm, about 1,000 nm, about 500 nm, about 400 nm, about 300 nm, about 200 nm, about 100 nm, about 80 nm, about 50, or about 10 nm. In some embodiments, characteristic pore size can be in the range of about 200 nm to about 2 μm, or about 10 nm to about 1 μm inclusive of all ranges therebetween. Controlling the pore size, the length of pores, and the number of pores can allow for greater control of the impregnating liquid flow rates, product flow rates, and overall material yield.

The impregnating liquid 120 is disposed on the surface 110 such that the impregnating liquid 120 impregnates the interstitial regions defined by the plurality of solid features 112, for example, pores, cavities, or otherwise inter-feature spacing defined by the surface 110 such that no air remains in the interstitial regions. The interstitial regions can be dimensioned and configured such that capillary forces retain part of the impregnating liquid 120 in the interstitial regions. The impregnating liquid 120 disposed in the interstitial regions of the plurality of solid features 112 is configured to define a second roll off angle less than the first roll off angle (i.e., the roll off angle of the unmodified surface 110. In some embodiments, the impregnating liquid 120 can have a viscosity at room temperature of less than about 1,000 cP, for example about 50 cP, about 100 cP, about 150 cP, about 200 cP, about 300 cP, about 400 cP, about 500 cP, about 600 cP, about 700 cP, about 800 cP, about 900 cP, or about 1,000 cP, inclusive of all ranges therebetween. In some embodiments, the impregnating liquid 120 can have viscosity of less than about 1 cP, for example, about 0.1 cP, 0.2 cP, 0.3 cP, 0.4 cP, 0.5 cP, 0.6 cP, 0.7 cP, 0.8 cP, 0.9 cP, or about 0.99 cP, inclusive of all ranges therebetween. In some embodiments, the impregnating liquid 120 can fill the interstitial regions defined by the solid features 112 such that the impregnating liquid 120 forms a layer of at least about 5 nm thick above the plurality of solid features 112 disposed on the surface 110. In some embodiments, the impregnating liquid 120 forms a layer of at least about 1 μm above the plurality of solid features 112 disposed on the surface 110. In some embodiments the plurality of solid features can have an average roughness, Ra, less than 0.8 μm, for example, in compliance with the rules and regulations of a regulatory body (e.g., the Food and Drug Administration (FDA)).

The impregnating liquid 120 may be disposed in the interstitial spaces defined by the solid features 112 using any suitable means. For example, the impregnating liquid 120 can be sprayed or brushed onto the textured surface 110 (e.g., a texture on an inner surface of a bottle). In some embodiments, the impregnating liquid 120 can be applied to the textured surface 110 by filling or partially filling a container that includes the textured surface 110. The excess impregnating liquid 120 is then removed from the container. In some embodiments, the excess impregnating liquid 120 can be removed by adding a wash liquid (e.g., water) to the container to collect or extract the excess impregnating liquid from the container. In some embodiments, the excess impregnating liquid may be mechanically removed (e.g., pushed off the surface with a solid object or fluid), absorbed off of the surface 110 using another porous material, or removed via gravity or centrifugal forces. In some embodiments, the impregnating liquid 120 can be disposed by spinning the surface 110 (e.g., a container) in contact with the liquid (e.g., a spin coating process), and condensing the impregnating liquid 120 onto the surface 110. In some embodiments, the impregnating liquid 120 is applied by depositing a solution with the impregnating liquid and one or more volatile liquids (e.g., via any of the previously described methods) and evaporating away the one or more volatile liquids.

In some embodiments, the impregnating liquid 120 can be applied using a spreading liquid that spreads or pushes the impregnating liquid along the surface 110. For example, the impregnating liquid 120 (e.g., ethyl oleate) and spreading liquid (e.g., water) may be combined in a container and agitated or stirred. The fluid flow within the container may distribute the impregnating liquid 120 around the container as it impregnates the solid features 112. In some embodiments, the impregnating liquid can be spray coated on the textured surface.

In some embodiments, the impregnating liquid 120 can include, silicone oil, a perfluorocarbon liquid, halogenated vacuum oil, greases, lubricants, (such as Krytox 1506 or Fromblin 06/6), a fluorinated coolant (e.g., perfluoro-tripentylamine sold as FC-70, FC-43, perfluorotributylamine FC-75, perfluoro(2-butyl-tetrahydrofurane), FC-72 (perfluorohexane) or perfluorotributylamine used in Fluosol and Fluorinert products manufactured by 3M), an ionic liquid, a fluorinated ionic liquid that is immiscible with water, a silicone oil comprising PDMS, a fluorinated silicone oil such as, for example polyfluorosiloxane, or polyorganosiloxanes, a liquid metal, a synthetic oil, a vegetable oil, an electro-rheological fluid, a magneto-rheological fluid, a ferrofluid, a dielectric liquid, a hydrocarbon liquid such as mineral oil, polyalphaolefins (PAO), or other synthetic hydrocarbon co-oligomers, a fluorocarbon liquid, for example, polyphenyl ether (PPE), perfluoropolyether (PFPE), perfluorodecalin, or perfluoroalkanes, a refrigerant (e.g., hydrofluoroether (HFE) liquids, Novec series liquids), a vacuum oil, a phase-change material, a semi-liquid, polyalkylene glycol, esters of saturated fatty and dibasic acids, polyurea, grease, synovial fluid, bodily fluid, or any other aqueous fluid or any other impregnating liquid described herein or any combination thereof.

The ratio of the solid features 112 (e.g., particles) to the impregnating liquid 120, can be configured to ensure that no portion of the solid features 112 protrude above the liquid-product interface. For example, in some embodiments, the ratio can be less than about 15%, less than about 5%, or less than about 1%. In some embodiments, the ratio can be less than about 50%, about 45%, about 40%, about 35%, about 30%, about 25%, about 20%, about 15%, about 10%, about 5%, or less than about 1%. In some embodiments, the ratio can be in the range of about 5% to about 50%, about 10% to about 30%, or about 15% to about 20%, inclusive of all ranges therebetween. In some embodiments, a low ratio can be achieved using surface textures that are substantially pointed, caved, or are rounded. By contrast, surface textures that are flat may result in higher ratios, with too much solid material exposed at the surface.

In some embodiments, the liquid-impregnated surface 100 can have an “emerged area fraction” φ, which is defined as a representative fraction of the non-submerged solid corresponding to the projected surface area of the liquid-impregnated surface 100 at room temperature, of less than about 0.30, about 0.25, about 0.20, about 0.15, about 0.10, about 0.05, about 0.01, or less than about 0.005. In some embodiments, φ can be greater than about 0.001, about 0.005, about 0.01, about 0.05, about 0.10, about 0.15, or greater than about 0.20. In some embodiments, φ can be in the range of about 0 to about 0.25. In some embodiments, φ can be in the range of about 0 to about 0.01. In some embodiments, φ can be in the range of about 0.001 to about 0.25. In some embodiments, φ can be in the range of about 0.001 to about 0.10.

In some embodiments, the liquid-impregnated surface 100 can have advantageous droplet roll-off properties that minimize the accumulation of the contacting liquid CL on the surfaces. Without being bound to any particular theory, in some embodiments, a roll-off angle which is the angle of inclination of the liquid-impregnated surface 100 at which a droplet of product placed on the textured solid begins to move, can be less than about 50°, less than about 40°, less than about 30°, less than about 25°, or less than about 20° for a specific volume of contact liquid. In such embodiments, the roll off angle can vary with the volume of the product included in the droplet, but for a specific volume of the contact liquid, the roll off angle remains substantially the same.

In some embodiments, the impregnating liquid 120 can include one or more additives to prevent or reduce evaporation of the impregnating liquid 120. For example, a surfactant can be added to the impregnating liquid 120. The surfactants can include, but are not limited to, docosenoic acid, trans-13-docosenoic acid, cis-13-docosenoic acid, nonylphenoxy tri(ethyleneoxy) ethanol, methyl 12-hydroxyoctadecanate, 1-Tetracosanol, fluorochemical “L-1006”, and any combination thereof. Examples of surfactants described herein and other surfactants which can be included in the impregnating liquid can be found in White, I., “Effect of Surfactants on the Evaporation of Water Close to 100 C.” Industrial & Engineering Chemistry Fundamentals 15.1 (1976): 53-59, the content of which is incorporated herein by reference in its entirety. In some embodiments, the additives can include C₁₆H₃₃COOH, C₁₇H₃₃COOH, C₁₈H₃₃COOH, C₁₉H₃₃COOH, C₁₄H₂₉OH, C₁₆H₃₃OH, C₁₈H₃₇OH, C₂₀H₄₁OH, C₂₂H₄₅OH, C₁₇H₃₅COOCH₃, C₁₅H₃₁COOC₂H₅, C₁₆H₃₃OC₂H₄OH, C₁₈H₃₇OC₂H₄OH, C₂₀H₄₁OC₂H₄OH, C₂₂H₄₅OC₂H₄OH, sodium docosyl sulfate (SDS), poly(vinyl stearate), poly (octadecyl acrylate), poly(octadecyl methacrylate) and any combination thereof. Further examples of additives can be found in Barnes, G. T., “The potential for monolayers to reduce the evaporation of water from large water storages,” Agricultural Water Management 95.4 (2008): 339-353, the content of which is hereby by incorporated herein by reference in its entirety.

### Methods of Preparing of Solid Particle Solutions for Forming Textured Surfaces

In some embodiments, the solid features 112 can be defined on the surface 110 to form a textured surface using a physical deposition process such as, for example, spray coating, dip coating, painting, etc. Examples of spray coating processes which can be used to dispose a solid particle solution or suspension on a surface are described in the '444 publication. In such embodiments, a solution, a suspension, or an emulsion of solid particles in a solvent can be prepared using the methods described herein which can be disposed (e.g., spray coated) on the surface 110 to form the textured surface.

In some embodiments, a method of preparing a colloidal suspension which can be spray coated on the surface 110 to form the textured surface includes dissolving a solid (e.g., any of the solids described herein) in a solvent heated to a first temperature Tₕ greater than room temperature Tᵣ, and then cooling the solution to a second temperature (e.g., room temperature). For example, the first temperature Tₕ can be about the boiling temperature of the solvent. The solid can have a concentration C such that substantially all the solid dissolves in the solvent at the first temperature Tₕ to form a solution. For example, the concentration C of the solid can be less than the saturation concentration of the solid in the solvent at the first temperature (Cₛₐₜ(Tₕ)) and greater than the saturation concentration of the solid in the solvent at room temperature (Cₛₐₜ(Tᵣ)). The solution can be formulated such that when the solution is cooled, at least a portion of the solid dissolved in the solution nucleates or otherwise precipitates to form micro or nanoscale particles suspended in the solvent, thereby forming a suspension, for example, a colloidal suspension. When the suspension is sprayed onto the surface 110, the particles can settle onto the surface 110 and the solvent can evaporate forming a non-smooth surface covered by particles or aggregates of particles which form the solid features 112, thereby forming the textured surface. In some embodiments, the solvent can include a substantially volatile solvent, for example, a solvent having a vapor pressure substantially higher than the vapor pressure of water. Such solvents can include, for example, ethanol, methanol, isopropanol, acetone, ethyl acetate, or any other volatile solvent described herein. In some embodiments, the solvent can include non-volatile solvent, for example, water or any other solvent having a vapor pressure substantially lower than water. In such embodiment, surface 110 can be allowed to evaporate naturally over a period of time, or heated (e.g., on a hot plate or an oven) to a temperature about the same or above the evaporation temperature of the solvent such that the solvent evaporates forming the textured surface.

The particles or aggregates of particles can adhere to the surface 110, for example, via van der Waal's forces, including hydrogen bonding. A portion of the solid that remains dissolved in the solution at room temperature can precipitate between the particles and/or particle aggregates disposed on the surface 110 as the solvent evaporates. This can increase the adhesion between the particles and/or the particle aggregates, or between the particle/particle aggregates and the surface 110 resulting in a robust textured surface. Said another way, the portion of the solid that remains dissolved in the solvent at room temperature serves as a binder to bind the particles and/or particle aggregates to each other, and/or to the surface 110. In some embodiments, the solid can be a first solid and the solution can include a second solid dissolved in the solvent such that the second solid serves as the binder. In some embodiments, the binder can be formulated to stabilize the solution. In some embodiments, the binder can include a silicone based sealant, glue, an adhesive, a wax, or any other binder described herein.

In some embodiments, the solution can be stored at a second temperature greater than room temperature Tᵣ. In some embodiments, the second temperature can be sufficient to maintain the solid in a partially dissolved phase or a completely dissolved phase. In some embodiments, the concentration of the solid C at the second temperature can be less than the saturation concentration of the solid at the first temperature (Cₛₐₜ(Tₕ)) such that the solid is maintained in the dissolved phase in the solution. Storing at the second temperature can substantially reduce or otherwise eliminate challenges associated with keeping the solid particles stably suspended in the colloidal suspension. In some embodiments, the colloidal suspension can also be sprayed onto the surface 110 to form the textured surface while maintaining the colloidal suspension at the second temperature. In some embodiments, micro and/or nanoparticles can be added to the solution or otherwise colloidal suspension during and/or before the cooling. Such micro and/or nanoparticles can serve as nucleating agents which can facilitate nucleating of the dissolved solid on the surface 110, and/or enhance a physical property, for example, a surface roughness of the textured surface.

In some embodiments, a method for forming a solid particle solution, suspension, and/or emulsion can include applying shear stress on solid particles mixed or dissolved in a solvent. For example, the solid particles can be homogenized or dispersed in the solvent using any suitable equipment, for example, homogenizers, dispersers, stirrers, mills, microfluidizers, blenders, any other shear stress producing equipment or a combination thereof. Such equipment can be used to produce a high shear stress in the solid particles suspended in the solvent which can break down particles agglomerates and create a uniform particle size reduction to produce a stable homogenized suspension of solid particles. For example, in some embodiments, an industrial blender which includes different size and shape blades at various speeds can be used to mix the solid particles and any other components included in the suspension. In addition, a homogenizer can be used to blend the solution and create a homogenous solution. In some embodiments, a microfluidizer, which is a high shear fluid processor, can be used to reduce the solid particle size to the nanometer scale, thereby creating a homogenous solid particle suspension.

In some embodiments, a method for forming a solid particle solution, suspension, and/or emulsion can include sonication. For example, ultrasonic frequencies (i.e., frequencies greater than about 20 kHz) can be used to agitate solid particles suspended in a solvent such that the particle agglomerates break down to micrometer or nanometer size scales and are evenly dispersed in the solvent to form the suspension. In some embodiments, sonication or otherwise ultrasonication can be used to introduce extensive nucleation in the solvent in a relatively short period of time. The solid particle suspension or otherwise solution can be subjected to ultrasonication using an ultrasonic bath or an ultrasonic probe. The size distribution, shape and crystallinity of the solid particles can be controlled by controlling the duration of the sonication, the ultrasonic frequency, or controlling the temperature of the ultrasonic bath. Furthermore, controlling these parameters can enhance the stability of the particles and slow the reaggregation process. In some embodiments, the solid particle suspension or solution can be supercooled and then subjected to ultrasonication to induce nucleation and facilitate the formation of a homogenously dispersed solution.

In some embodiments, the solid can only be partially soluble in the solvent. In such embodiments, the solid can be heated to a temperature T at or above the melting point Tₘ of the solid such that the solid melts. Heating can be performed using any suitable apparatus, for example, a hot plate, a heat jacket, an oven, a furnace, a heat gun, any other suitable heating equipment or a combination thereof. The melted solid can then be mixed with the solvent and emulsified into the solvent using any suitable method such as, for example, ultrasonication, agitation, blending, stirring, mixing, sparging, homogenization, any other suitable method, or a combination thereof. In some embodiments, the emulsification can be performed at a temperature at or above the melting point Tₘ of the solid particles. This can facilitate the dissolution and/or dispersion of the solid in the solvent and can, for example, create a supersaturated solution or emulsion. The solution can be cooled to room temperature which can, for example, yield a cloudy or milky suspension including micro and/or nano scale dispersions of the solid particles in the solvent.

In some embodiments, an electric field can be used to induce nucleation in a solution of solid particles. For example, the solid suspended or dissolved in a solvent can include electrically conductive particles (e.g., metallic particles) or charged particles. The electric field can be applied using electrodes or probes immersed in the solution, electrically conductive containers, or using any other method or a combination thereof. The electric field can include a strong static or oscillating electric field. In some embodiments, the electric field can yield needle shaped (e.g., acicular) particles homogenously suspended in the solution.

In some embodiments, a magnetic field can be used to induce nucleation in a solution of solid particles. For example, the solid suspended or dissolved in the solvent can include magnetic particles (e.g., ferromagnetic particles such as, for example, iron oxide particles) or charge particles. The magnetic field can include an alternating magnetic field, or a unidirectional magnetic field (e.g., a negative unidirectional magnetic field. The magnetic field can be aligned with the atoms of the solid particles which can increase the energy state and velocity of the electrons. This can allow the electrons to orient their orbits in synergy with applied magnetic field which can reduce van der Waal's forces and entropic effects that cause agglomeration and instability. Furthermore, the magnetic field can increase the zeta potential of the atoms as a result of the higher energy state leading to substantial nucleation and/or enhance stability of the suspension. The magnetic field can increase the nucleation kinetics and accelerate crystal growth rate. The magnetic flux density and the exposure time can be varied to control the crystal growth rate. Any suitable source of magnetic flux can be used to apply the magnetic field, for example, a temporary magnet, a permanent magnet, or an electromagnet.

In some embodiments, a microwave can be used to induce nucleation in a solution of solid particles. For example, a container of the solid particle suspension or solution can be wrapped with a microwave coil, or disposed in a microwave oven to generate microwaves in the solid particle suspension or solution. The microwave can induce nucleation of particles in the solvent to produce homogenous suspensions and/or emulsions of solid particles. The particle size, structure and/or crystallinity can be varied by controlling the intensity of the microwave radiation.

In some embodiments, laser irradiation can be used to induce nucleation in a solid particle solution or suspension. In such embodiments, the laser can, for example, induce cavitation creating a bubble and thus a cavity which can serve as a nucleation site for the solid particles. Furthermore, the laser can create a localized hot or cold zone in the solid particle solution which can induce nucleation. In some embodiments, a magnetic ink (e.g., a ferrofluid ink) can be added to the solid particle solution to facilitate the absorption of the laser energy into the solution. Any suitable laser can be used to induce nucleation such as, for example, an Nd-YAG laser, a helium-neon laser, an argon laser, a krypton laser, a xenon laser, a nitrogen laser, a carbon dioxide laser, a carbon monoxide laser, an excimer laser, a solid state laser, a dye laser, a chemical laser, any other suitable laser, or a combination thereof.

In some embodiments, impurities or dopants can be added to a solid particle suspension or otherwise solution to induce nucleation. The presence of dopants or impurities in the solid particle suspension or solution can substantially impact the nucleation behavior of the solid particles in the solvent. Any suitable dopant having any suitable physical or chemical structure and/or size can be added to the solid particle suspension or solution to induce nucleation. Suitable dopants can include, for example, adipic acid, benzoic acid, ascorbic acid, kaolin, talc, any other suitable dopant or a combination thereof. In some embodiments, the dopant can include inorganic materials having a small average particle size and a high melting point.

In some embodiments, nucleation can be induced in a solid particle suspension or solution by increasing the surface area of the solid particle solution. For example, in some embodiments, the solid particle solution can transferred to a wide base container to increase the surface area and facilitate nucleation. In some embodiments, cooling fins can be added to a container of the solid particles to increase the surface area and induce nucleation. In some embodiments, the container housing the solid particle suspension or solution can have a surface energy which can facilitate nucleation of the solid particles.

In some embodiments, nucleation can be induced in a solid particle solution or suspension by seeding the solution with a small quantity of the solid particles or any other material which can induce nucleation and/or facilitate crystallization of the sold particles in the solution. For example, the seeding material can include small particles of the solid particles which can be added to a supersaturated solution of the solid particles to induce nucleation. The size of the seed particles or crystals can affect the size, quantity, and/or distribution of the solid particles nucleated in the solution. In some embodiments, the seeding particles can include metal balls (e.g., steel balls), wooden balls, salt crystals, any other suitable seeding particle or a combination thereof.

In some embodiments, a solid particle suspension or colloidal dispersion can be created using a bottom up approach which can include any suitable reactive or wet chemistry process. For example, in some embodiments, a sol-gel process can be used to make colloidal dispersions of the solid particles in the solvent. In such embodiments, reactive groups capable of forming particles by lysis and condensation in a solvent can be used to form the solid particle suspension or colloidal dispersion. For example, metal alkoxides in alcohol can be hydrolyzed in the presence of an acid or base catalyst and then condensed by dehydration to produce the solid particle suspension or colloidal dispersion. In some embodiments, micro and/or nanoparticle synthesis can be performed by precipitation, polymerization, agglomeration, crosslinking of particles, flocculation, and/or aggregation in a solution. Any suitable polymerization protocol can be used such as, for example, addition, condensation, ionic condensation, cationic condensation, anionic condensation, free radical method, and/or step growth method. In some embodiments, templated growth and/or self assembly can be used to produce the solid particle suspension using precursors, nanoparticles or scaffolds to nucleate and growth the solid particles.

In some embodiments, the solid particles can include polymerized particles such that the solid particle suspension or colloidal dispersion can be produced using conjugation. In some embodiments, the conjugated polymer particles can be synthesized by partially emulsifying a solution of a conjugated polymer in an aqueous medium that can include one or more solvents. In some embodiments, the conjugated polymer solution can be injected or otherwise communicated into a liquid which is miscible with the solvent but not with the polymer. This can lead to rapid precipitation of the conjugated polymer forming particles.

In some embodiments, supercritical fluids can be used to produce solid particle suspensions or colloidal distributions. The supercritical fluids can exchange solvents or non-solvents from the solid particle solution to produce particle suspensions. For example, in some embodiments, a solid particle suspension can be desired in a low boiling point solvent (e.g., diethyl ether) but the particles can only be produced in a high boiling point solvent (e.g., xylene). In such embodiments, the solid particles can be produced in the high boiling point solvent and then subjected to the supercritical fluid solvent exchange process to remove the high boiling point solvent from the solid particles. The high boiling point solvent can then be replaced with the low boiling point solvent to yield the particle suspension.

In some embodiments, photoinduced crosslinking can be used to produce solid particle suspensions or colloidal distributions. For example, the solvent can include monomers that are capable of producing free radicals by reacting to photons of sufficient energy. Such monomers can include photosensitive moieties such as, for example, vinyl groups, epoxide groups, acrylate or methacrylate groups, any other photosensitive monomer, photoinitiators or a combination thereof. In some embodiments, ultraviolet (UV) light can be used to initiate the photo crosslinking. The photosensitive moieties can be monomers or oligomers. Photoinduced crosslinking can result in creation of particles in the solvent by cross-linking in 1, 2, and 3 dimensions to yield the solid particle suspension or colloidal distribution. The extent of the crosslinking, as well as, particle shape and size can be controlled by the time period of the exposure, energy of the photons, intensity of the radiation, temperature of the solid particle solution and/or the concentration of the photosensitive moieties in the solid particle solution.

In some embodiments, milling can be used to reduce a size of the solid particles to a predetermined size or shape. Milling can be performed on dry solid particles or solid particles suspended or dispersed in the solvent. Any suitable mills or milling method can be used to reduce the particle size such as, for example, ball mill, planetary mill, wet mill, cement mill, vertical roller mill, arbor mill, any other suitable mill or a combination thereof. In some embodiments, cryomilling (also known as freezer milling or freezer grinding) can be used to reduce the particle size. In such embodiments, the solid particles or solid particle solution is first cooled, for example, to cryogenic temperatures and then milled or crushed to the desired particle size. The cooling temperature and/or the time of the milling can be used to control the size of the solid particles. In some embodiments, the milling can include ultrasonic wet milling. In such embodiments, as solid particle suspension having large sized particles or agglomerates can be used to produce ultrafine particle suspensions by subjecting the solid particle suspension to ultrasonic cavitation. The ultrasonic waves can produce alternating low and high frequency rarefaction and compression cycles, localized high temperatures and/or pressures which can break up the particles into a smaller size scale. In some embodiments, the milling process can be used to grind the solid particles into a fine powder.

In some embodiments, electrospraying and/or electrospinning can be used to create solid particles in a solvent. In such embodiments, particles and fibers are created in a stream of liquid with a suspension, dispersion or solution by applying an electric field and collecting the resultant material. This can create fibers, particles, or agglomerates of the particles from the solution which can be suspended in a solvent to form the solid suspension. For example, the particles can include metal oxide or ceramic particles which can be formed by electrospraying onto the surface 110 to form the textured surface. In some embodiments, stream of liquid can include proteins and metal alkoxide gels which can be sprayed or spun by an electric field. In some embodiments, the liquid which can include dissolved or dispersed polymer solutions can be drawn from a metallic needle, charged to a high electric voltage and disposed on a surface which can be grounded to obtain the solid particles (i.e., electrospun) which can be used to form a solid particle suspension or colloidal solution.

In some embodiments, spray drying can be used to create the solid particles which can be used to form solid suspensions or colloidal dispersions. In some embodiments, the spray drying process can be used to create dry particles by subjecting a suspension of solid particles to a hot gas. For example, any hot gas such as, for example, air or nitrogen can be used to heat particles or dissolved solids in a liquid or a slurry to rapidly dry out the particles or precipitate out the dissolved solids and form dry particles. This can produce particles having substantially uniform size distributions.

In some embodiments, atomization can be used to produce solid particles of a predetermined size. The atomization process can include the use of atomizers or spray nozzles to produce consistent droplet sizes on spraying which can result in the production of substantially uniform size particles. Suitable atomization methods can include, for example, single fluid, dual fluid or mixed fluid nozzles, rotary atomizers, ultrasonic atomizers, and electrostatic atomizers. Single fluid, dual fluid, or mixed fluid atomizers utilize the kinetic energy of the pumped fluid and variations in nozzle size and/or shape to break up fluids into smaller droplets. Rotary atomizers include a high speed rotating wheel, disc or cup to discharge liquid via centrifugal force to produce the droplets. In some embodiments, the atomizer can include ultrasonic atomizers which produce narrow particles size distribution by creating capillary waves which initiates low velocity spray. In some embodiments, the solid can be melted into a liquid which can then be atomized using any of the atomizers described herein to produce the solid particles. In some embodiments, piezo nozzles can be used to produce ultrasmall droplets of the solid particle solution, suspension, or molten solid. In some embodiments, atomization can be used to produce droplets of the solid particles which encapsulate an additive and can provide controlled release of the additive.

In some embodiments, the size or distribution of solid particles included in a solid particle suspension can be controlled by the rate and/or degree of supersaturation of the solid particle solution or otherwise suspension. As described herein, a supersaturated solution has a dissolved concentration of the solid in the solvent which is higher than the solubility of the solid in the solvent. A solution held in supersaturated state is thermodynamically unstable and the portion of the solid dissolved in the solvent which exceeds the solubility of the solid, will eventually precipitate into the solvent. The size and number of particles that precipitate out into the solution depends on the rate and degree to which the solution is brought into the supersaturated state. Faster and higher supersaturation leads to a higher number of small particles, while slower and lesser supersaturation leads to a smaller number of large particles.

The rate and degree of supersaturation can be controlled using various techniques. In some embodiments, a solution can be supersaturated by rapidly cooling or supercooling a solid particle solution. For example, in some embodiments, the solid particle solution can be disposed in a container which can be quenched in an ice bath, dry ice, liquid nitrogen, or any other rapid cooling medium. In some embodiments, highly conductive materials (e.g., cooled metal balls or any other shape or size thermally conductive object) can be added to the solution in high volumes urging the temperature of the solid particle solution to drop rapidly. For example, ¼ inch metal balls (e.g., steel, copper, aluminum, alloys, any other suitable metal or combination thereof) can be added to solid particle solution to produce nanometer size scale solid particles in the solid particle solution. The metal balls can then be removed from the solution to yield the solid particle suspension. In some embodiments, the metal balls or otherwise thermally conductive object can be cooled to a temperature below room temperature, to about zero degrees Celsius or even below before immersing in the solid particle solution to increase the rate and degree of supercooling. Furthermore, the rate of supercooling can be varied by the controlling the surface area of the metal balls or otherwise objects immersed in the solid particle solution, the heat capacity of the material, and/or the conductivity of the material used to form the object.

In some embodiments, heat exchangers can be used to supercool the solid particle solution and supersaturate the solid particle solution. Any suitable heat exchanger can be used such as, for example, double pipe heat exchangers, plate heat exchangers, adiabatic wheel heat exchangers, shell and tube heat exchangers, plate fin heat exchangers, pillow heat exchangers, any other suitable heat exchangers or a combination thereof. In some embodiments, a low temperature solid or liquid which is substantially more volatile than the solvent can be added to the solid particle solution and supercool the solid particle solution. Such solids and/or liquids can include, for example, dry ice, liquid nitrogen, or a supercooled volatile liquid which is substantially more volatile than the solvent. Once the solid or liquid is added to the solid particle solution, the solid or liquid can supercool the solid particle solution and then be allowed to evaporate out of the solid particle solution.

In some embodiments, the solid particle solution can be supercooled by adding a liquid to the solid particle solution in which the solid has a very low solubility. This can urge the resulting mixture of the solid particle solution and the liquid to be supersaturated. In such embodiments, the particle size distribution and/or quantity can be controlled by varying the rate of addition of the liquid, the quantity of the liquid added, and/or the ratio of the solvent included in the solid particle solution and the added liquid. For example, an increase in the average particle size of the solid particles can decrease with increasing rate and volume of the liquid added to the solid particle solution.

In some embodiments, the solid particle solution can be supercooled by evaporating at least a portion of the solvent included in the solid particle solution. Evaporation of the solvent increases the concentration of the solid particles dissolved in the solvent urging the solution to become supersaturated. The degree of supersaturation and/or particle size distribution can be controlled by controlling the degree of evaporation. The degree of evaporation can be controlled using any suitable method such as, for example, atomization of the solution into drops (e.g., by spraying the solution) which leads to increase in the surface area of the solution and rapid evaporation of the solvent, bubbling a gas through the solid particle solution, increasing the temperature of the solution, and subjecting the solid particle solution to a vacuum.

In some embodiments, the solid particle size distribution in the solid particle suspension can be controlled by adding or mixing different types of solvents, for example, different polarity and/or having different solubility of the solid particle in the solvent. Use of different solvents can be used to phase segregate the components of the solid particle solution or colloidal distribution and control the particle size distribution of the solid particles in the solution. For example, a solid that is soluble in a polar solvent will have limited or no solubility in a non-polar solvent. Thus introduction of a non-polar solvent into a polar solid particle solution can induce nucleation of small or large particles in the solid particle solution. Expanding further, a non-polar solid will dissolve in a non-polar solvent such as, for example, heptane. If a polar solvent such as, for example, ethyl acetate is added to this solution, at least a portion of the solid particles will precipitate as solid particles. In some embodiments, the solid can be soluble in polar as well as non-polar solvents. In such embodiments, a mixture of polar and non-polar solvents (i.e., a solvent and a co-solvent) can be used to more effectively disperse the solids in the solid particle solution which includes the polar and non-polar solvents. In some embodiments, the solid can act as an emulsifier and enhance the stability of the solid particle solution. Furthermore, the drying or evaporation time of the solvent can be controlled by the choice of the co-solvent, for example, the drying time of water can be decreased by adding ethanol to the water.

In some embodiments, the size distribution of the solid particles can be controlled by fractionation. Fractionation involves separating particles of different size suspended in a solvent into different groups based on their size. Any suitable fractionation technique can be used to separate the particles into the different size groups. In some embodiments, the fractionation can include field flow fractionation in which any suitable field (e.g., electrical, magnetic, gravitational, thermal, centrifugal, etc.) is applied to a solid particle suspension or colloidal distribution that includes solid particles of various sizes that have different mobilities in the field. In some embodiments, different size particles suspended in a solid particle solution can be fractionated using diffusion performed in a laminar flow profile. Larger size particles can, for example, diffuse slower than smaller size particles leading to the separation of the solid particles into various size fractions. In some embodiments, the fractionation process can include pinch flow fractionation which involves separation of the solid particles in a solid particle solution into dispersions of various sizes by pinching a mixed particle size distribution suspension with a particle free liquid flow. In such embodiments, the pinched portion of the solid particle solution can have a much smaller particle size distribution.

In some embodiments, particles of different sizes suspended in the solid particle suspension can be separated using a combination of filtering, centrifugal force, and gravitational force respectively. For example, the combination of these methods can be used to break down particle agglomerates. Filtration can include any suitable filtering method such as, for example, gravity driven filtration or vacuum driven filtration. Filter cones of different pore sizes (e.g., Buchner funnel, belt funnel, rotary vacuum-drum filter, cross-flow filters, screen filter, etc.), filtering pipets, and suction set-ups can be used to perform the filtration. In some embodiments, the gravitational separation can be done via a gravity table.

In some embodiments, particles of different sizes suspended in the solid particle suspension can be separated using decantation. In such embodiments, the separation of solid particle solutions into different particle sizes can be achieved by removing a top layer of solution which includes a settled precipitate. In this manner, larger particles can be removed from the solid particle solution leaving the smaller solid particles in the solid particle solution. A centrifuge can be used to help with the process by forcing the larger particles to the bottom of the container. Furthermore, decantation can be used in addition to solvent extraction/mixing, based on the immiscibility and different densities.

In some embodiments, particle size and distribution produced in a solid particle solution can be controlled by adding nucleating agents to the solid particle solution. Different particles can be added as nucleating agents, providing sites where the particles can grow in a controllable size and homogeneity. The nucleating agent has a high surface energy as well as a high surface area. Any suitable nucleating agent can be used such as, for example, talc. In some embodiments, the nucleating agent can be include co-polymers or block co-polymers. In some embodiments, nucleation can be induced in the solid particle solution by bubbling of a gas (e.g., carbon dioxide) or a liquid (e.g., water) into the solid particle solution. The bubbles can provide nucleation sites for inducing growth of the solid particles in the solid particle solution.

In some embodiments, a first solid particle solution including a first particle size distribution can be mixed with a second solid particle solution that includes a second particle size distribution. For example, the first solid particle solution can include a micrometer solid particle size distribution and the second solid particle solution can include a nanometer solid particle size distribution. This can yield a mixture of the first solid particle solution and the second solid particle solution that includes a hierarchical distribution of micrometer and nanometer size particles.

Due to very strong van der Waals interactions, micro/nano sized particles in a solid particle solution can be unstable and tend to agglomerate leading to phase separation and reduction of the solid features 112 formed on the surface 110 to form the textured surface. Various methods can be used to control the stability of micro/nano particle suspensions, protecting them from aggregating. In some embodiments, the stability of the solid particles in a solid particle suspension can be controlled by physical agitation of the solid particle solution. Suitable physical agitation methods can include, for example, fluids agitation, sonication, stirring, blending, shaking, vibration, natural convection, gas bubbling, recirculation, any other suitable physical agitation method or a combination thereof. For example, solid particle agglomeration can be substantially reduced by subjecting the solid particle solution to ultrasonication. Such an ultrasonicated solid particle solution can have a substantially longer shelf life than an untreated solid particle solution.

In some embodiments, additives can be added into the solid particle solution to enhance the stability of the solid particle solution. For example, in some embodiments, surfactants can be added to a solid particle solution to stabilize the suspended particles and prevent them from aggregation, thus helping with the even dispersion of the small particles in the solution. In some embodiments, the surfactants can be used to provide micellar control of nucleation to create phases, based on one medium/solvent (or media/solvents) with different sizes and shapes within another medium/solvent (or media/solvents). The size and shape can be controlled by picking surfactants using the hydrophilic-lipophilic balance (HLB) value. HLB system is based on segregating surfactants micellar control of nucleation or control size/degree of agglomeration by adding coagulating agents or changing pH, or tuning HLB values to control degree of coagulation. In some embodiments, the surfactants can include volatile surfactants such as, for example, fluorocarbons, which can function as wetting agents and stabilizers in the solid particle suspension. Such volatile surfactants can evaporate once the solid particle solution is sprayed on the surface 110 to create the textured surface.

In some embodiments, the surfactants can include long-chain surfactants and polymers which can effectively avoid fast sedimentation of the solid particles suspended in the solid particle suspension due to steric repulsion. Such surfactants can include, for example, amphiphilic molecules such as pluronic acid, cetyl trimethylammonium bromide (CTAB), glycoside, Triton X-100, homopolymers, random copolymers, block copolymers, grafted polymers, any other suitable surfactant or a combination thereof. Such surfactants can effectively absorb onto the surface of particles serving as protective layers to increase the stability of particle suspensions.

In some embodiments, the stability of a solid particle suspension or otherwise colloidal dispersion can be enhanced by adding pH control additives to the solid particle solution. For example, the pH control additives can provide strong electrostatic repulsion to keep the solid particles separated due to the formation of electrical double-layers around the particles. The solid particles with higher surface potential would be kinetically stable in the solution. For example, aqueous ammonia, NaOH, KOH, or any other base may be used in small amounts to increase pH.

In some embodiments, polar protic and polar non-protic solvents can be added to a solid particle solution to enhance the stability of the solid particle solution. Such polar solvents can provide stable net charges on the particle surfaces. These net charges can lead to repulsion of the particles thereby enhancing the stability of the solid particle solution. Suitable polar aprotic solvents can include, for example, dichloromethane, tetrahydrofuran, ethyl acetate, acetone, dimethylformamide, acetonitrile, dimethyl sulfoxide, and propylene carbonate. Suitable polar protic solvents can include, for example, formic acid, n-butanol, isobutanol, n-propanol, ethanol, methanol, acetic acid, nitromethane, and water.

In some embodiments, a solid particle solution can be stabilized by introducing particles in the solid particle solution having a different particle distribution to the size distribution of the solid particles in the solid particle suspension. For example, smaller size particles can be added to a solid particle solution that includes solid particles of a larger size. The smaller particles can be interspersed between the larger size particles and stabilize the larger size particles. The smaller particles can include uncharged or charged particles which can stabilize the solid particle solution by providing steric or electrostatic repulsion with the larger particles to prevent the formation of agglomerates and thereby enhancing the stability of the solid particle solution.

In some embodiments, the stability of a solid particle suspension or otherwise colloidal distribution can be enhanced by storing the solid particle solution at a temperature different than room temperature. For example, in some embodiments, the particles suspension can be stored at a temperature lower than room temperature which can prevent agglomeration of the solid particles thereby enhancing the stability of the solid particle suspension. At lower temperature, the mobility of the solid particles can decrease leading to much slower aggregation. In some embodiments, the solid particle suspension can be stored a temperature higher than room temperature to enhance the stability of the solid particle solution. The solubility of the solid particles in the solvent can increase at elevated temperatures. This can urge the solid particles to transition from a suspended phase in the solvent to a dissolved phase such that the solid particles have a higher stability in the solid particle solution.

In some embodiments, the use of adhesion promoters as part of a solution to render a tie layer between the polymer of choice forming the solid portion of the liquid impregnated surface and a substrate material to which the impregnating solid does not have sufficient adhesion. For example, a high percent solids (e.g., Polyester >10% weight by volume) solution with the addition of up to 1.4 weight percent of a hybrid carboxy/hydroxyl functional metal organic adhesion promoter in order to improve adhesion to metal surfaces, acrylonitrile butadiene styrene polymer, and treated propylene/polyethylene.

In some embodiments, the stability of the solid particle suspension or colloidal distribution can be enhanced and aggregation of the solid particles included in the solid particles minimized by increasing the viscosity of the solid particle solution. By increasing the dynamic viscosity of the suspension, the mobility of solid particles decreases, which can lead to the formation of a more stable solid particle suspension. The viscosity of the solid particle solution can be increased by adding one or more thickening agents to the solid particle suspension. Any suitable thickening agents can be added to the solid particle solution such as, for example, polyethylene glycol, polyacrylic acid (carbomer), vegetable gums, polyurethane, polyvinyl alcohol, clays, cellulosics, sulfonates, proteins, agars, organosilicones, any other suitable thickening agent or a combination thereof.

In some embodiments, additives can be added to the solid particle solution, suspension or colloidal distribution to affect the properties of the textured surface formed by spray coating the solid particle solution on the surface 110. For example, in some embodiments, crosslinkable agents can be added to enhance adhesion of the solid textures to the substrate and to enhance the durability of the solid textures. Such agents can be formulated to be crosslinked using any suitable mechanism such as, for example, chemical reactions, that are initiated by heat, pressure, pH, photon, UV radiation or any other suitable crosslinking mechanism. Suitable crosslinking agents can include, for example, polymers such as polyurethane, polyacrylamide, polyethylene, polycarbonate, polydicyclopentadiene, epoxy resin, any other crosslinking agent or a combination thereof. The crosslinking agents can be mixed with a solid suspension at a predetermined volumetric ratio such that the adhesion or stability of the textured surface formed by spray coating the solid particle solution on the surface 110 is improved without affecting the surface roughness and surface chemistry of the textured surface

In some embodiments, binders can be incorporated into the solid particle suspension, solution, or colloidal distribution to increase the adhesion of the textured surface formed by spray coating the solid particle solution on the surface 110. For example, in some embodiments, a textured surface formed by spray coating a solid particle solution on the surface 110, can have poor adhesion to the surface 110. The textured surface thus formed, however, can provide the most suitable properties for incorporating an impregnating liquid 120 to form a liquid-impregnated surface, which provides the most suitable properties towards a predetermined product slide over the liquid impregnated surface. In such embodiments, a binder can be added to the solid particle solution to increase the adhesion of the formed textured surface on the surface 110. Suitable binders can include, for example, adhesives, glues, waxes, epoxies, sealants (e.g., a silicone based sealant) any other suitable binders or combination thereof. The binders can be added to the solid particle solution at relatively small volumetric ratios such that the wettability of the impregnating liquid within the solid features 112 formed by the textured surface is not impacted. In some embodiments, the binders can be formulated to be cured to bind with the solid particle surface, for example, after the solid particle solution has been spray coated on the surface 110 to form the textured surface. The binder can be formulated to be cured using any suitable curing process such as, for example, drying, moisturizing, UV curing, heating, maintaining at room temperature for a predetermined period of time, any other suitable curing process or a combination thereof.

In some embodiments, one or more reactive materials can be added to the solid particle solution to enhance the adhesion of the textured surface to the surface 110. Such reactive materials can, for example, be formulated to interact with the solid particles suspended or otherwise dissolved in the solid particle suspension or solution, respectively, and enhance the adhesion of the solid particles to the surface 110. In this manner, a stable and robust textured surface can be formed. Suitable reactive materials can include, for example, silanes, monomers, crosslinking agents (e.g., thiols, phosphonates, etc.) any other suitable reactive material or a combination thereof. In some embodiments, the reactive materials can be formulated to form a self assembled monolayer (SAM) on the surface 110. For example, octadecyltricholorosilane molecules react with a hydroxyl group on a substrate to form a very stable covalent bond. Solid particles treated with thiol groups such as dodecane thiol molecules can then bind to the SAM layer via thiol-metal covalent bonds. The SAM can provide a chemical linker to bind the solid particle to the surface 110. In some embodiments, the surface 110 can be pretreated using a suitable physical or chemical surface treatment process to facilitate the formation of the SAM on the surface 110. Suitable surface treatment processes can include, for example, plasma treatment, corona treatment, chemical treatment, electric arc treatment, reactive gas treatment, pH buffer treatment, sandblasting, sanding, adding a coating such as a binder and/or an adhesive layer, and any other suitable treatment process or combination thereof. In some embodiments, the surface treatment process can be performed before spray coating the surface 110 with the solid particle solution. In some embodiments, the surface treatment process can be performed after spray coating the surface 110 with the solid particle solution.

In some embodiments, the adhesion of the solid particles to the surface 110 for forming the textured surface can be substantially enhanced by adding surface modifying agents intended to control surface energy, hydrophobicity, and/or chemistry of the formed textured surface. For example, the surface energy of the surface 110 can be increased to increase the work of adhesion between the solid particles and the surface 110 and thereby, enhance the adhesion of the solid particles to the surface 110. In some embodiments, the adhesion of the solid particles to the surface 110 can be substantially increased by reducing the interfacial energy between the solid particles and surface 110 and/or increasing the surface energy of solid particles. In some embodiments, the interfacial energy can be reduced by modifying the surface 110 to have similar surface chemistry (e.g., hydrophobicity, hydrophilicity, oleophobicity, metallophillicity, etc.) to the solids particles. For example, beeswax solid particles can have better adhesions to a substrate that has been pretreated with fluorine molecules (i.e., fluorinated surface modifiers, such as Solvay FluoroLink products). In some embodiments, a polymer such as, for example, polyethylene, polypropylene, or polystyrene can be disposed on the substrate to enhance the adhesion of the solid particle to the substrate. Such treatment processes can substantially enhance the adhesion of the solid particles that form the textured surface on the surface 110 which would otherwise have insufficient adhesion on the surface 110. In this manner, any solid particles can be stably disposed on the surface 110 regardless of the inherent adhesion of the solid particles to the surface 110. This can allow the best combination of solid particles and impregnating liquid to be disposed on any surface to obtain a liquid-impregnated surface that provides the optimal slipping or physico/chemical properties towards a product or otherwise a contact liquid.

In some embodiments, additives can be added to the solid particle solution, suspension or colloidal distribution to impart or alter a physical or chemical property to the textured surface formed by spraying the solid particle solution on the surface 110. For example, additives can be added to the solid particle solution or suspension to alter a melting point, chemical stability, diffusivity (i.e., diffusivity to the impregnating liquid and/or the contact liquid), insulative properties, any other suitable property or a combination thereof. Depending on the application of the final textured surface formed on the surface 110, the solid particle solution or suspension can be modified to impart certain specific physical and/or chemical properties to the solid particle solution or suspension. For example, in some embodiments, the liquid-impregnated surface formed by impregnating an impregnating liquid 120 in a textured surface can be configured to maintain slippery properties at temperatures which are substantially higher than ambient or room temperatures. In such embodiments, the stability of the textured surface can be enhanced and the slippery properties of the liquid-impregnated surface towards a can be maintained by including additives in the solid particle solution or suspension. Other properties which can be enhanced or altered include, for example, thermal conductivity, electrical conductivity, elastic modulus, Young's modulus, mechanical strength, creep properties, etc. Thus the additives can be added to the solid particle solution to ensure that the liquid-impregnated surface formed by spray coating the solid particle solution on the surface 110 has the desired physical or chemical properties and/or to ensure that the physical and/or chemical properties of the liquid-impregnated surface remain unaltered during use.

In some embodiments, the physical or chemical properties of the textured surface formed by spray coating a solid particle solution or suspension can be controlled by adding one or more components to the solid particle solution in different concentrations. For example, in some embodiments, the hydrophilicity of a solid particle solution or suspension can be increased by adding a concentration of a hydrophilic component (e.g., a hydrophilic polymer) to a solid particle solution that includes a hydrophobic polymer. Conversely, the hydrophobicity of a solid particle solution or suspension can be increased by adding a concentration of a hydrophobic component (e.g., a hydrophobic polymer) to a solid particle solution that includes a hydrophilic polymer. In some embodiments, the polarity of the textured surface formed by spraying a solid particle solution or suspension can be altered by adding a more non-polar or a more polar component (e.g., a solid, liquid, or particle) to the solid particle solution or suspension. The added component can be mixed with the solid particle solution or it can be sprayed as a separate layer on top of the initial spray coated solid particle solution, i.e., the textured surface, so that the resulting final textured surface shows the expected properties. In this manner, the physical and chemical properties of the textured surface can be tuned by mixing different components.

In some embodiments, additives such as surfactants can be added to a solid particle solution, suspension or colloidal distribution to enhance spreading or otherwise wetting of the solid particle solution or suspension (or the solvent included in the solid particle solution or suspension) by altering the spreading coefficient of the solid particle solution or suspension on the surface 110. The spreading coefficient can be expressed by Young-Dupre equation, which states that if spreading coefficient is larger than zero, then a liquid will wet a solid surface completely. When the spreading coefficient is smaller than zero, partial wetting happens. Since efficient coating of the surface 110 by the solid particle solution to form a uniform textured surface generally occurs when the solid particle solution or suspension completely wets the surface, enhancing the spreading of the solid particle solution on the surface 110 can improve the quality of the textured surface. Any surfactant can be added to the solid particle solution or suspension to improve the spreading coefficient of the solid particle solution or suspension such as, for example, anionic, cationic, and non-ionic surfactants or emulsifiers. By reducing the surface tension of the solvent with the surfactant, a non-wetting solid suspension can be made to become partially or completely wetting. This can reduce particle aggregation on the substrate, and change the solvent evaporation time resulting in a more uniform coating, for example, a solid coating.

In some embodiments, additives can be added to the solid particle solution, suspension or colloidal distribution to reduce the rate of evaporation of the solvent included in the solid particle solution. For example, in some embodiments, the solvent included in the solid particle solution may have a low boiling point resulting in a very high evaporation rate that can interfere with the nucleation and growth of solid particles on the surface 110 and result in a non-uniform textured surface, or a textured surface having inter feature spacing or any other property which is not optimal. In such embodiments, additives such as, for example, triethanolamine, salts, co-solvents, any other additive or a combination thereof can be added to the solution to retard or otherwise slow down the evaporation rate of the solvent resulting in a more homogenous and uniform textured surface, and better penetration into the inherent features of the surface 110 the solid particle solution for better adhesion.

In some embodiments, the solid particle solution, suspension or colloidal distribution can include dissolved gases. Such gases can be dissolved in the solid particle solution, suspension, or colloidal distribution under increased pressure, for example, a pressure higher than atmospheric pressure. For example, in such embodiments, the solid particle solution or suspension can be stored in a pressurized container to maintain the gas in the dissolved state. When the solid particle solution or suspension is spray coated on the surface 110, the gas can bubble out of the solution or suspension due to depressurization. This can cause nucleation or otherwise bubbling of gases from the disposed solid particle coating leading to a porous textured surface. This can increase roughness, yield a more stable textured surface, and/or increase the adhesion of the textured surface. Any gas can be dissolved in the solid particle solution to yield the porous textured surface. Such gases can include, for example, oxygen, carbon dioxide, air, non-reactive gases such as, nitrogen, argon, any other suitable gas or a combination thereof.

In some embodiments, phase change materials can be added to the solid particle solution, suspension or colloidal distribution to control the roughness and/or interstitial spacing of the textured surface. Phase change materials can change their phase, for example, transition between solid, liquid, or gaseous phases, when subjected to an appropriate treatment process, for example, exposure to UV light, heat, moisture, etc. Some phase changing materials can have a high heat of fusion which can enable the phase change materials to melt or solidify at a certain temperature or under certain physical conditions (e.g., exposure to UV light). Incorporation of such phase change materials in the solid particle solution or suspension can lead to a significant saving in solvent consumption and more controllable formation of solid textures. In some embodiments, such phase change materials can include subliming materials, such as, for example, camphor, dry ice, iodine, naphthalene, any other suitable subliming material or a combination thereof.

In some embodiments, the solid particles included in a solid particle solution or suspension can include a plurality of components having different properties which can be separated into one or more components from the bulk solution based on their properties. For example, the components of the solid particle solution can have different melting points, solubilities, surface chemistries, polarity, ionic charge, and/or generally different physical and/or chemical properties. The components of the solid particles can be separated out in the solution based on their different chemical properties (e.g., solubility). Any one of the components of the solid particles can be separated from the solid particle solution such that the solid particle solution includes only a single component of the solid. The removed component can then be used to prepare a separate solid particle solution which includes the separated component of the solid as the solid particles. For example, beeswax can include a first component and a second component which have different solubilities in a solution, or at different temperatures. The first component can have a higher solubility in the solvent at a higher temperature than the second component. To separate the first component and the second component from the beeswax, the beeswax can be added to the solvent and the temperature of the solvent increased. In some embodiments, this can urge the first component to dissolve while the second component remains suspended in the solvent in particulate form. Said another way the first component can form a first phase (e.g., a liquid phase) and the second component can form a second phase (e.g., a suspension) such that the second phase floats over the first phase. In some embodiments, each of the first component and the second component can dissolve in the solvent at the higher temperature. However, a first portion of the solution that includes the first component can have a lower or higher density than the second portion of the solution that includes the second component. This can urge the first portion of the solution to separate from the second portion of the solution because of the difference in densities. In some embodiments, the second component can have a higher melting point than the first component such that when the solution is cooled the first component precipitates or otherwise solidifies from the solvent before the second component. This can, for example, be observed visually (e.g., by observing a color change of the solution). The second component can then be removed from the first component using any suitable process such as, for example, decantation, filtration, scraping, any other suitable separation process or a combination thereof. The remaining solution will only include the first component of the beeswax. The first component can now be urged to nucleate and form solid particles formed from only the first component in the solvent using any nucleation process described herein (e.g., supercooling, quenching, supersaturation, etc.). The solid particle solution formed exclusively of the first component of beeswax can now be spray coated on the surface 110 to form a textured surface. The second component can be dissolved or suspended in a solvent (e.g., the same solvent or a separate solvent) to form a solid particle solution which can also be spray coated on the surface 110 to form the textured surface.

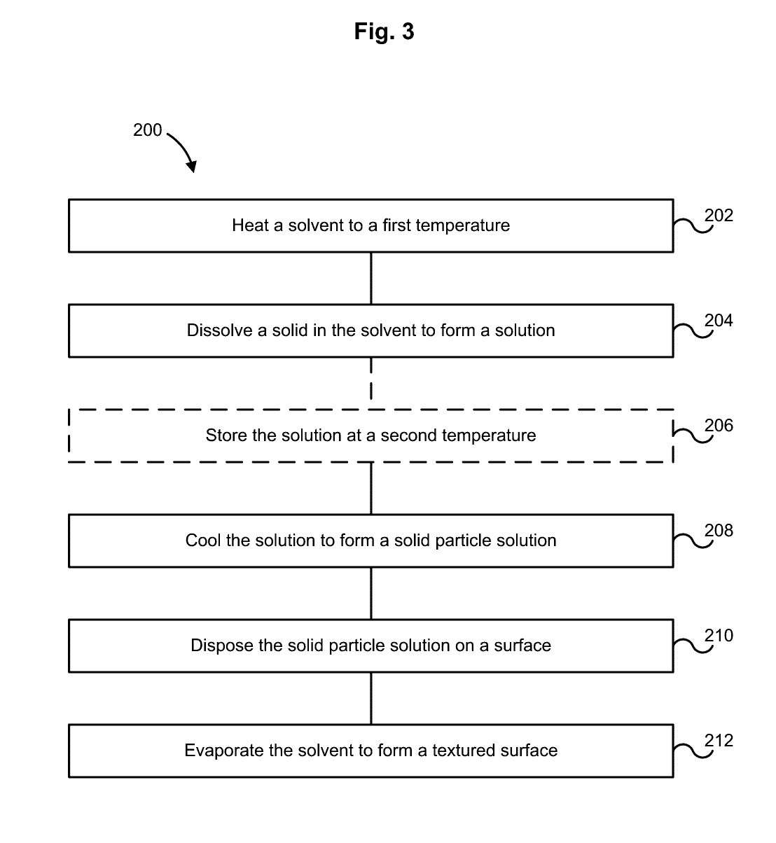

FIG. 3 shows a schematic flow diagram of a method 200 of forming a textured surface, which can be used to form a textured surface. The method 200 includes heating a solvent to a first temperature Tₕ, at 202. The solvent can include any solvent described herein such as, for example, water, acetone, ethanol, isopropanol, methanol, ethyl acetate, hexane, heptane, toluene, or any other suitable solvent described herein or a combination thereof. In some embodiments, the first temperature can be substantially equal to the boiling point of the solvent. A solid is dissolved in the solvent to form a solution, at 204. The dissolved solid has a concentration C which is less than the saturation concentration of the solid in the solvent at the first temperature (Cₛₐₜ(Tₕ)) and is greater than the saturation concentration of the solid in the solvent at room temperature (Cₛₐₜ(Tᵣ)) (i.e., Cₛₐₜ(Tᵣ)<C<Cₛₐₜ(Tₕ). In some embodiments, a binder, for example, a silicone based sealant or any other binder described herein, can also be dissolved in the solution. The binder can, for example, be formulated to enhance adhesion of the textured surface formed by spray coating a surface with a solid particle solution prepared using the method 200. In some embodiments, a surfactant can also be dissolved in the solution. The surfactant can include any of the surfactants described herein and can be formulated to modify the surface chemistry of the textured surface. In some embodiments, the surfactant can be formulated to enhance the wettability of the textured surface formed by spray coating the solid particle solution on the surface. In some embodiments, the surfactant can be formulated to maintain the solid, for example, solid particles in at least one of a partially or completely dissolved phase in the solvent. In some embodiments, microparticle or nanoparticles can be added to the solution, for example, to serve as nucleation sites for growth of solid particles in the solution, and/or stabilize solid particles suspended in the solid particle suspension. Optionally, in some embodiments, the solution can also be stored at a second temperature greater than room temperature which is sufficient to maintain the solution in at least one of a partially dissolved phase or a completely dissolved phase in the solution, at 206. In some embodiments, the solution can be stored at a second temperature at which C<Cₛₐₜ(Tₕ) such that the solid can be maintained in a completely dissolved phase in the solution.

The solution is then cooled to room temperature, at 208. The cooling can urge the solution to become supersaturated. As the temperature of the supersaturated solution decreases toward room temperature, solid particles begin to nucleate and eventually precipitate out of the solution and become suspended in the solvent thereby, forming a solid particle solution. In some embodiments, the solution can be cooled to a temperature below room temperature to increase the degree of supersaturation and/or to control the distribution and size of particles suspended in the solid particle solution. The solid particle solution can then be disposed on a surface, at 210, for example, spray coated on a surface or disposed using any suitable process described herein. The solvent is then evaporated from the solid particle solution to form the textured surface, at 212. The textured surface formed using the method 200 can be impregnated with an impregnating liquid, for example, any of the impregnating liquids described herein to form a liquid-impregnated surface.

In some embodiments, a solid particle suspension can be prepared with the impregnating liquid. For example, an impregnating liquid is heated to a first temperature 80 degrees Celsius, at which temperature a solid is dissolved completely in the liquid, forming a solution. The solid has a concentration which is less than the saturation concentration of the solid in the impregnating liquid at the first temperature and greater than the saturation concentration of the solid in the impregnating liquid at the room temperature. The solution is initially cooled to a second temperature, 0-30 degrees Celsius, at given rate, which is typically a room temperature or storage temperature, while dissolved solid forms a solid suspension. The resulting solid suspension in the impregnating liquid is disposed on a surface to create a liquid impregnating surface. In some embodiments, a solvent is added to the heated impregnating liquid which enables dissolving a larger amount of solid at the first temperature.

In some embodiments, a compatible solvent can be added to the solid particle suspension at the storage temperature to partially dissolve some solid. The dissolved portion of solid can provide additional adhesive force to the substrate after solvent evaporated from the solid particle solution to form a robust textured surface.

In some embodiments, the melting point of the solid may be lower than the boiling point of the impregnating liquid. The solid suspension can be prepared by adding a solid to the impregnating liquid at a first temperature higher than the melting temperature of the solid. An emulsion of the molten solid and impregnating liquid can be formed at the first temperature by any means discussed above. The emulsion is cooled down to the storage temperature to form a solid suspension.

In some embodiments, the melting point of the solid may be higher than the boiling point of the impregnating liquid. The solid suspension can be prepared by adding a solid to the impregnating liquid at a first temperature to increase the partial solubility of the solid particles within the impregnating liquid. A suspension of the solid can be formed by decreasing the liquid temperature to a second temperature which is typically room temperature or storage temperature.

In some embodiments, the particle size distribution of the solid particles in the suspension can be tuned by controlling the cooling rate of the solution from the first to the second temperature. In some embodiments the size distribution of the solid particles can be controlled by changing the agitation speed, strength of the homogenization process, power of the ultrasonication, flow rate and chamber size/shape of the microfluidizer process, and rate of heat exchange depending on which method been used to induce nucleation. The embodiments can be used individually or in combination to control size distribution of the solid particles. In some embodiments, the large particles in the solid suspension can be removed during or after the solution preparation process by the means of, for example, filtration, centrifugation, decantation or gravitational settlement.

In some embodiments, the solid particles can be composed of multiple components with different melting temperatures. The solid particles can be prepared as a mixture prior to the nucleation process or used as an additive after the nucleation process to modify the texture of the liquid impregnating surface.

The following examples show textured surfaces for using solid particle solutions prepared using the methods described herein. Such textured surfaces can be used to form liquid-impregnated surfaces with higher stability and longer life. These examples are only for illustrative purposes and are not intended to limit the scope of the present disclosure.

### Example 1

### Preparing a Supersaturated Solid Particle Solution

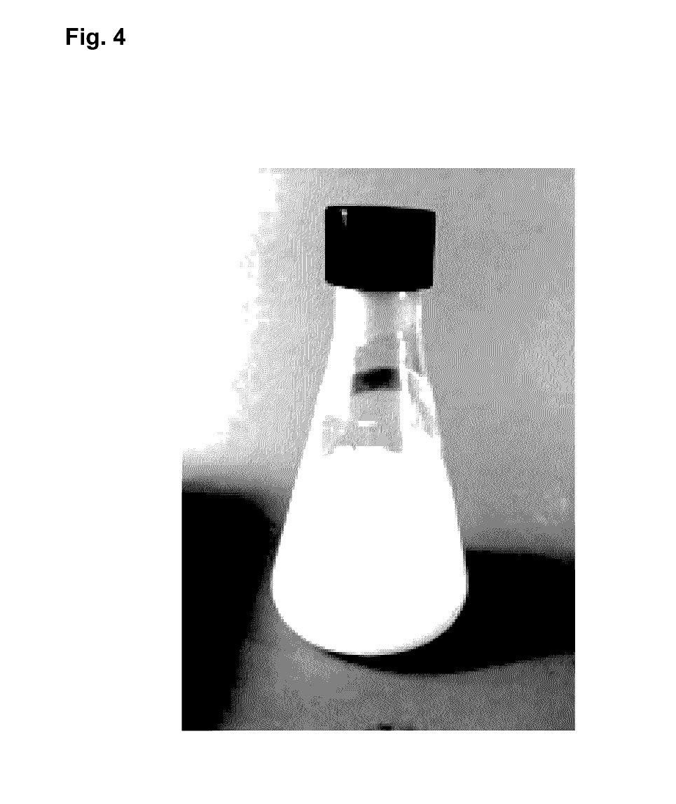

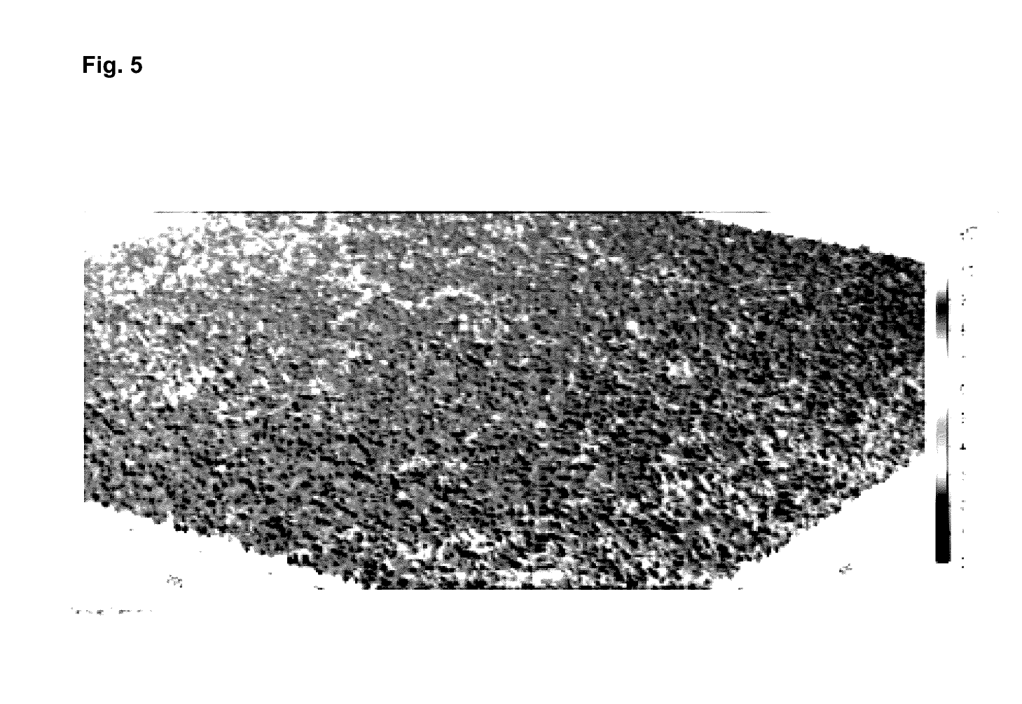

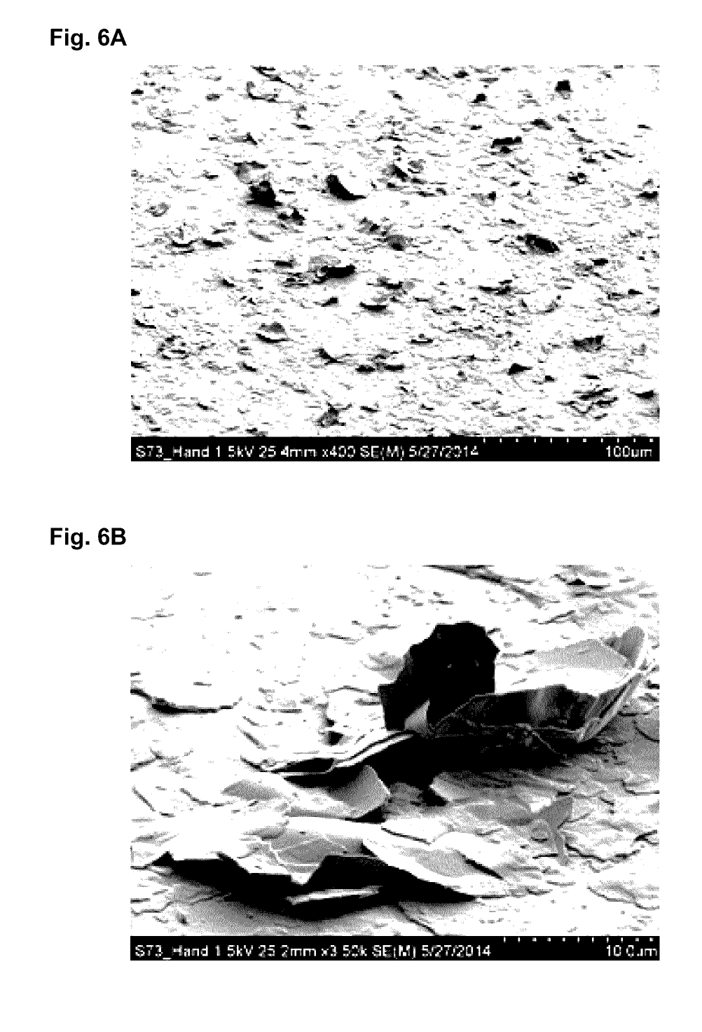

Example 1 describes a method of forming a rice bran wax solid particle suspension. To form the rice bran wax solid particle solution, 1% (w/v) rice bran wax was dissolved in boiled ethanol to form a solution. The solution was then cooled to room temperature while being subjected to ultrasonication. The solubility of the rice bran wax in ethanol is much lower than 1% (w/v) at room temperature. Thus cooling the solution to room temperature urged a portion of the rice bran wax to precipitate in the ethanol. After 30 minutes of sonication, a stable white colored milky rice bran wax-ethanol emulsion was obtained as shown in FIG. 4. This emulsion was spray coated on the inner surface of a transparent 8 oz PET bottle leading to a non-smooth surface covered by a plurality of particles or particle aggregates forming the textured surface. The textured surface had substantial adhesion to the PET surface because of van der Waal's forces. Furthermore, the dissolved portion of the rice bran wax in the ethanol at room temperature precipitated between the disposed rice bran wax solid particles as the ethanol evaporates, further enhancing adhesion. The surface topography of the textured surface was studied using interferometry (Taylor Hobson, CCI HD). FIG. 5 shows an interferometry image of the textured surface formed using the rice bran wax solid particle solution. The root mean square (RMS) roughness was determined to be about 1 μm, and the complexity was about 40%. FIG. 6A shows a SEM image of the textured surface and FIG. 6B shows a higher magnification image of a portion of the textured surface shown in FIG. 6A. The textured surface formed using the rice bran wax solid particles defined interstitial spacing which is sufficient to hold a suitable impregnating liquid such as, for example, polypropylene glycol di(caprylate/caprate), or any other impregnating liquid described herein, and form a liquid-impregnated surface. Since rice bran wax is safe for human consumption, such a liquid-impregnated surface can be used to reduce the roll of angle of a surface in contact with a product meant for human consumption (e.g., toothpaste, mayonnaise, corn syrup, honey, tomato sauce, salsa, jams, jellies, ice cream, yogurt, cottage cheese, or any other product described herein). Furthermore, the rice bran wax textured surface prepared using the method described herein can be formed on any suitable substrate such as, for example, PET, low density polyethylene (LDPE), high density polyethylene (HDPE) stainless steel, aluminum, or any other substrate defined herein.

### Example 2

### Enhancing Solid Particle Adhesion Using a Binder

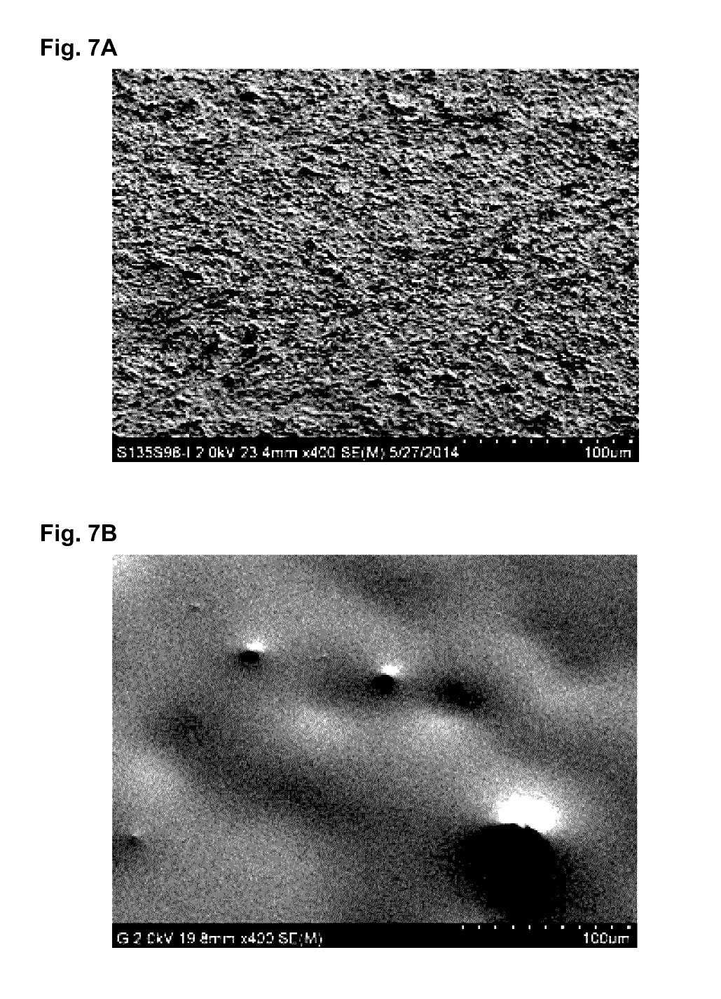

In this example, a silicone based sealant was added to a solid particle solution to serve as a binder for increasing the adhesion of a textured surface by spray coating a solid particle solution on a surface. A solid particle solution was formed by dissolving 3 grams of silicon wax (such as GP-533 GPC Silicon, Inc.) in 100 ml heptane. The solution was heated to about 60 degrees Celsius until the silicone wax was completely dissolved in the heptane. The solution was quenched in an ice bath while ultransonicating the solution. This urged the silicone wax to nucleate into microscale and nanoscale solid particles which were suspended in the solvent. Silicone wax particles however, have low adhesion to PET and HDPE surfaces. To improve the adhesion of the silicone wax, 2 grams of a silicone based sealant (e.g., RTV 118, Momentive, Inc.) was added to the solid suspension. The added sealant is desirable to be soluble in the solvent. The viscosity of the solid suspension increased as the sealant was added. The solid particle suspension was then spray coated on the inner surface of an 8 oz PET container. As the solvent evaporated, the silicone based sealant dried on the surface and bound with the silicone wax particles thereby, adhering the solid particles to the surface. FIG. 7A shows an SEM image of the textured surface formed by spray coating the solid particle solution revealing a uniform textured surface. In contrast, FIG. 7B shows a coating of only the silicon based sealant on the surface revealing a substantially smooth surface thus confirming that the sealant increases adhesion of the solid particles to the surface.

### Example 3

### Separation of Solids into Separate Components

In this example, beeswax was separated into a first component and a second component based on the solubility of each component in different solvents, namely ethyl acetate and ethanol. To perform the separation, 2 grams of beeswax was added to ethanol boiled at a temperature of about 78 degrees Celsius. The first component of the beeswax dissolved in the boiling ethanol forming a transparent ethanol solution while the second component settled to the bottom of the container housing the ethanol. This implies that the first component has high solubility in ethanol while the second component has poor or otherwise negligible solubility in the ethanol. The top transparent layer of the first component ethanol solution was separated from the second component and disposed in a metal can. The metal can was disposed in an ice-water mixture in a sonicator to rapidly cool the first component solution. The first component solution was sonicated for 20 minutes until a homogenous cloudy solution was obtained that included solid particles of the first component suspended in ethanol. The undissolved second component was added to hot ethyl acetate until substantially all the second component dissolved in the ethyl acetate to form a transparent solution of the second component. The second component solution was then cooled to room temperature under ultrasonication. This produced microparticles of the second component of the beeswax suspended in ethyl acetate, thereby producing a solid particle suspension of the second component of the beeswax.

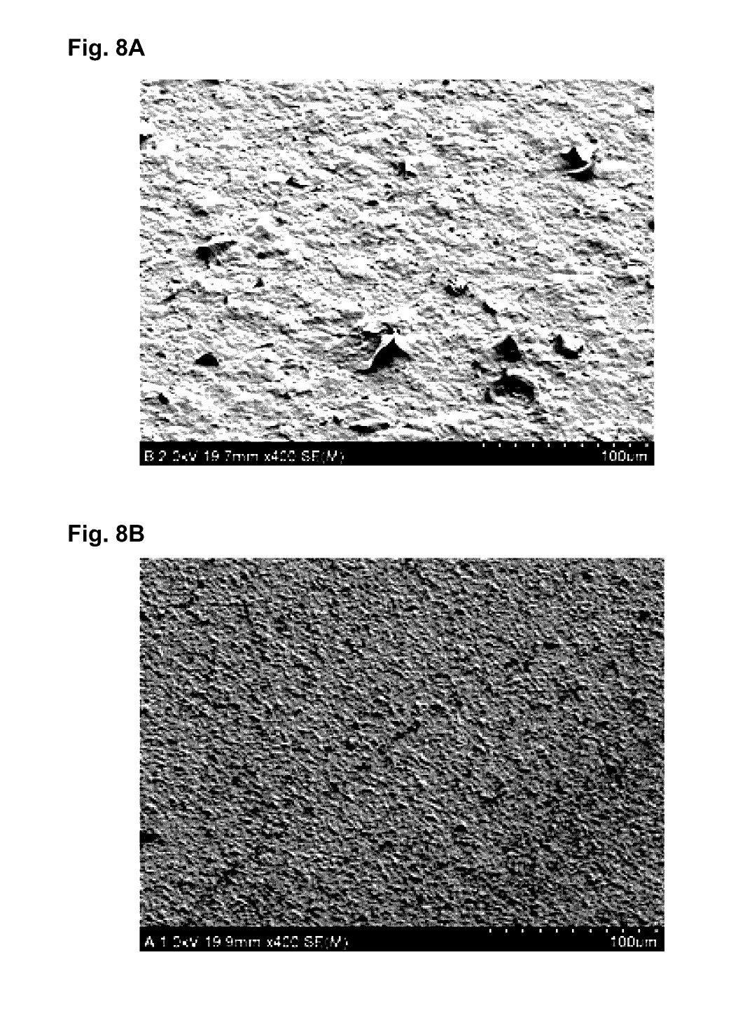

Each of the first component solid particle solution and the second component solid particle solution was spray coated on the inner surface of PET containers and the ethanol solvent was allowed to evaporate to form a textured surface. FIG. 8A shows and SEM image of the textured surface formed by spraying the first component solid particle solution on the PET container. As shown in FIG. 8A, the textured surface was generally flaky with sharp features. The emerged area fraction φ of an impregnating liquid in the textured surface was very small leading to a reduced pinning area. In contrast, FIG. 8B shows a SEM image of a textured surface formed by spray coating the solid particle solution of the second component onto a PET surface and allowing the ethyl acetate solvent to evaporate. The solid features included in the textured surface were generally round and small which can lead to a higher emerged area fraction φ of an impregnating liquid. This can affect the sliding performance of a product on a liquid-impregnated surface formed by impregnating the textured surface with an impregnating liquid as a product has a higher possibility of getting pinned on liquid-impregnated surfaces that have a high emerged area fraction φ.

### Example 4

### Changing Solvents to Alter Solid Particle Size Distribution

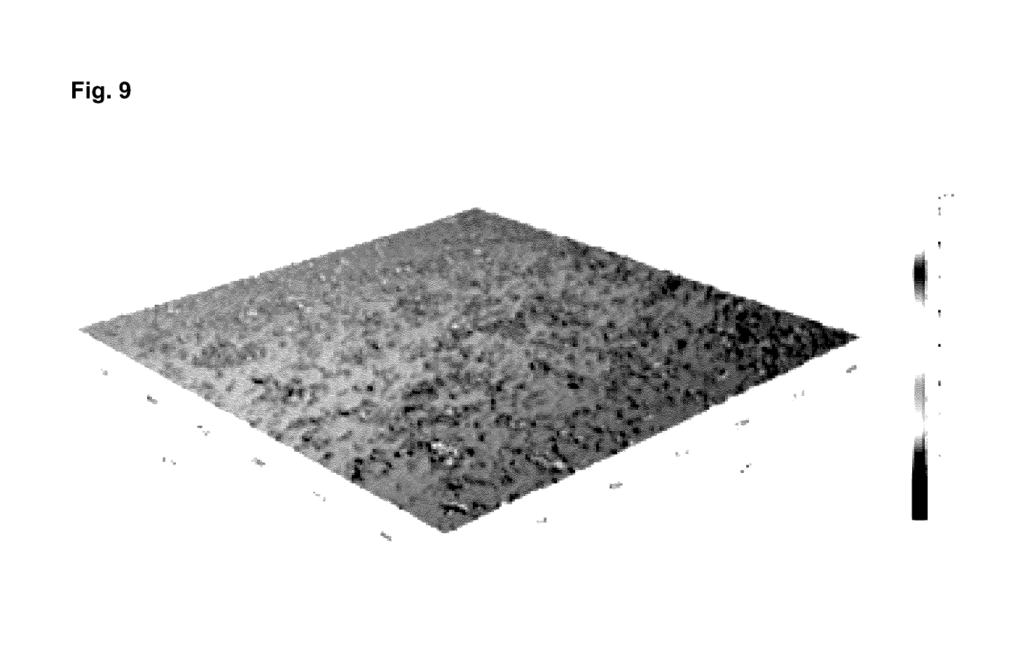

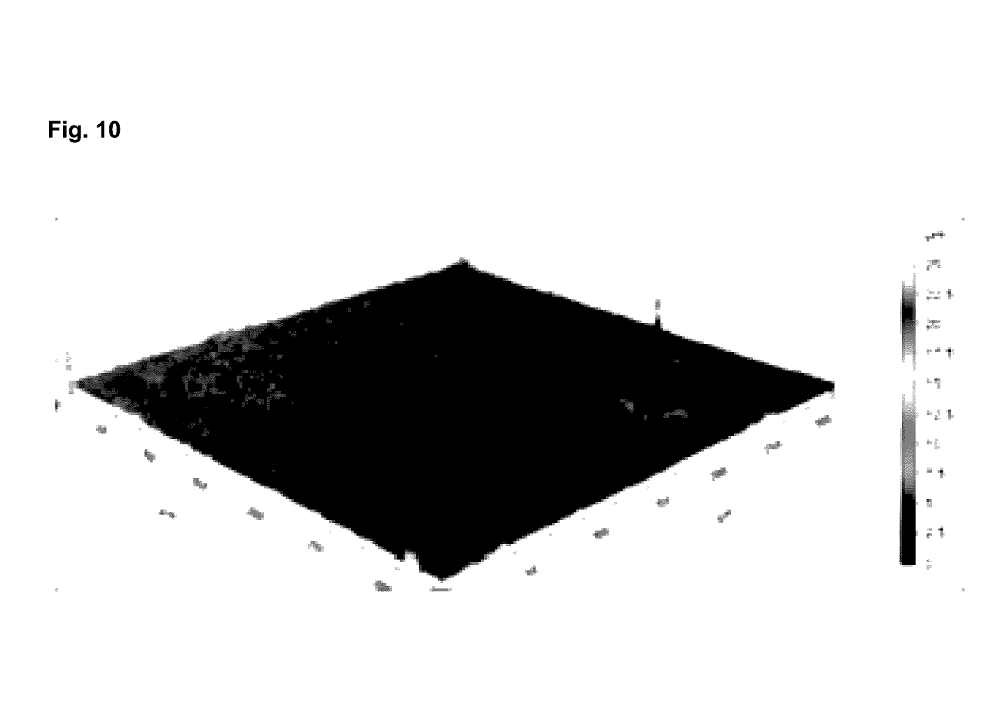

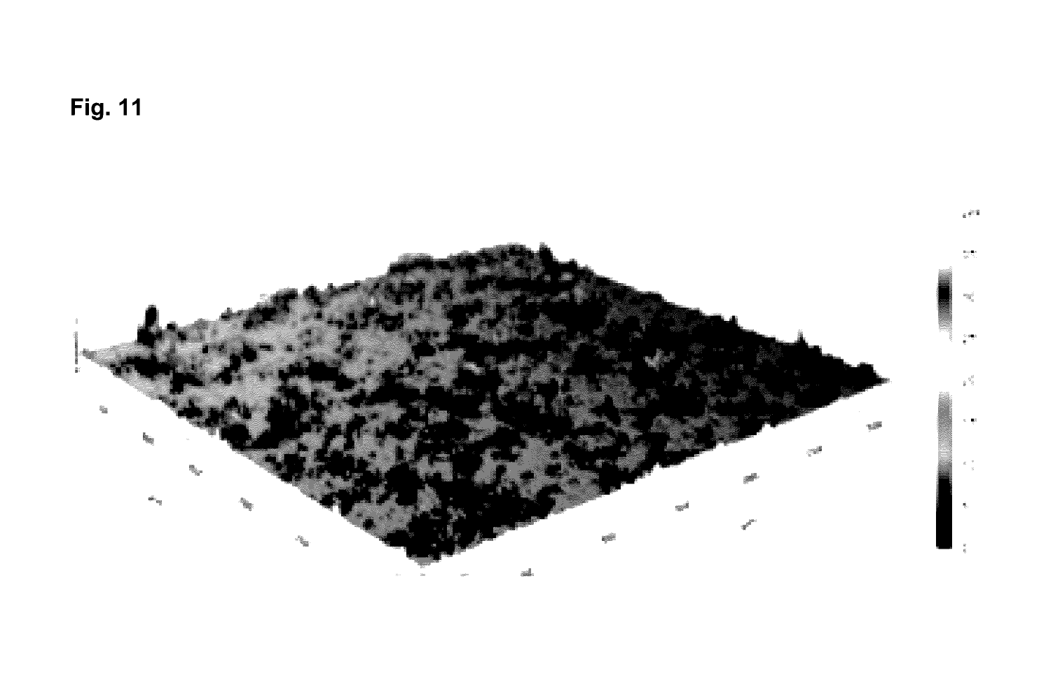

In this example, emulsions of rice bran wax were prepared in three different solvents to obtain solid particle solutions having different particle size distribution. More specifically, rice bran wax is soluble in diisopropyl ether, insoluble in ethanol, and partially soluble in isopropyl alcohol. The particle size distribution of the solid features formed by spraying a solid particle solution of rice bran wax can be controlled by the choice of solvent in which the rice bran wax is suspended or dissolved and is based on the solubility of the rice bran wax in the solvent. Solid particle solutions of rice bran wax was prepared by dissolving rice bran wax in ethanol boiled at 78 degrees Celsius, isopropyl alcohol boiled at 83 degrees Celsius, and diisopropyl ether boiled at 70 degrees Celsius respectively. Each of the solutions was cooled to room temperature to obtain solid particle suspensions of rice bran wax in each of the solvents. Each of the solid particle suspensions was spray coated on an inner surface of a PET container and the solvent allowed to evaporate to form textured surfaces. FIG. 9 shows a topographic interferometry image (Taylor Hobson, CCI HD) of a first textured surface formed by spray coating the solid particle solution of the rice bran wax in ethanol. The first textured surface includes a uniform distribution of solid features on the PET surface. FIG. 10 shows a topographic interferometry image (Taylor Hobson, CCI HD) of a second textured surface formed by spray coating the solid particle solution of the rice bran wax in diisopropyl ether. The second textured surface had a solid texture that includes large solid features having an average height of about 20 μm, which are interspersed with a plurality of small solid features. FIG. 11 shows a topographic interferometry image (Taylor Hobson, CCI HD) of a third textured surface formed by spray coating the solid particle solution of the rice bran wax in isopropyl alcohol. The third textured surface was substantially rougher than the first textured surface and the second textured surface, and included large solid features interspersed with small solid features.

### Example 5

### Mixing Salt as an Additive to Water-Base Wax Emulsion

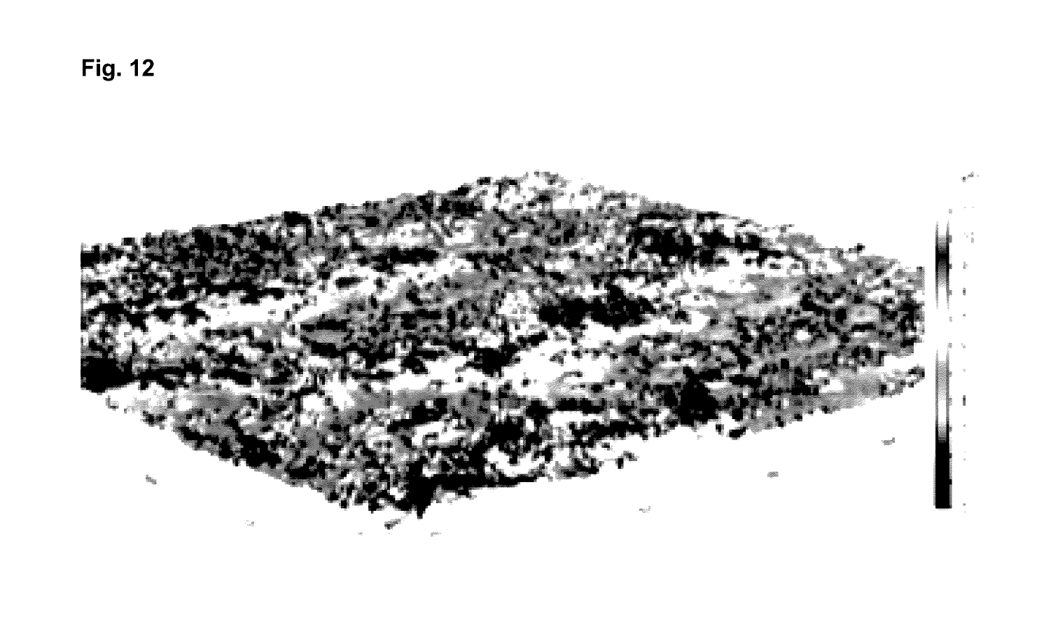

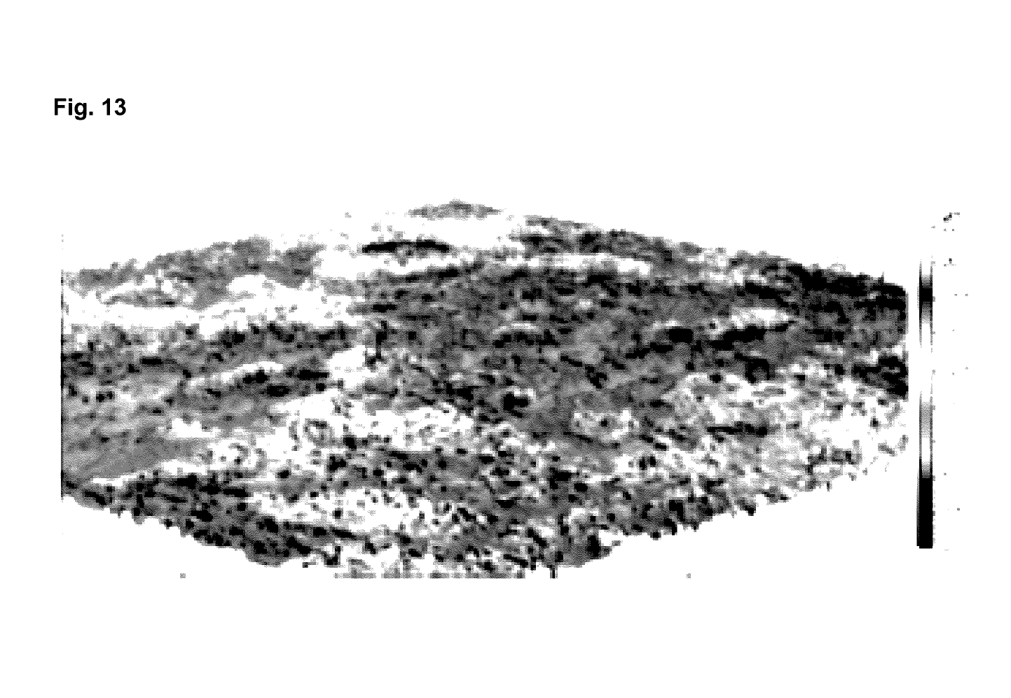

In this example, salt was added to an emulsion of carnauba wax in water to increase the surface roughness and create a uniform textured surface. A water based carnauba wax emulsion (Syncera 1407, Paramelt.com) was used for this example. This carnauba wax emulsion is widely used as a direct food additive for coating fruits to enhance the buffability and glossiness of such fruits. A textured surface formed by disposing the carnauba wax emulsion on a surface is too smooth to be stably impregnated with a solid particle solution. To increase the roughness of the textured surface, salt particles were dissolved in the carnauba wax such that the salt can nucleate on the surface to create the desired textured surface. About 1 grams of sodium chloride salt was added to about 10 grams of the carnauba wax emulsion and the solution was well mixed. The concentration of the sodium chloride was substantially below the saturation concentration of the salt in the emulsion, and thus all the salt dissolved in the emulsion. The emulsion was then spray coated on an inner surface of a PET container and the solvent allowed to evaporate for 30 seconds. A cloudy textured was formed on the surface due to nucleation of the salt molecules on the surface. FIG. 12 shows an interferometry image (Taylor Hobson, CCI HD) of the textured surface formed on the PET container. The surface had a complexity of about 58% and the weight of the solid coating was about 0.05 grams. The solid features can be stably impregnated with a higher quantity of the impregnating liquid with a lesser emerged area fraction φ relative to the textured surface formed by spray coating a carnauba wax emulsion which does not include the salt. The salt particle solid features formed on the surface can however, be soluble in a product, for example, an aqueous contact liquid. To over come this, the textured surface that included the salt particles was overcoated with a coating of the carnauba wax emulsion which did not include the salt. This created a “sandwich” coating such that the textured surface had salt particle solid features covered with a carnauba wax layer which prevents the salt particles from coming in direct contact with the product and protects the salt from being dissolved in the product. FIG. 13 shows an interferometry image (Taylor Hobson, CCI HD) of the textured surface after overcoating with the carnauba wax emulsion. The overall complexity of the textured surface was reduced by about 15% indicating that the salt particles are covered and protected by a carnauba wax coating. Multiple layers of the salt-carnauba wax emulsion and carnauba wax emulsion can be disposed on the surface to achieve the desired surface roughness, complexity, particle size distribution, surface chemistry, and or stability or otherwise robustness of the textured surface.

While various embodiments of the systems, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above.

For example, in some embodiments, a high melting point solid can be dissolved in a first solvent that has a high boiling point to prepare the solid particle solution or otherwise suspension. Once the solution is formed, a second solvent that has a lower viscosity and/or a lower boiling point can be added to the solid particle solution, or the first solvent replaced by the second solvent. The lower viscosity of the second solvent can facilitate spray coating of the solid particle solution while the lower viscosity can accelerate the evaporation rate. In some embodiments, a solid particle solution can be formed by adding a high molten point solid in molten state to a low boiling point solvent to accelerate dissolution. Ultrasonication can also be performed to accelerate the dissolution process. In some embodiments, high vapor pressure solvents can be used in the solid particle solution to increase the degree of atomization when the solid particle is spray coated on a surface. In some embodiments, quantum dots or fluorescent particles can be added to the solid particle solution or suspension to add color, fluorescence or biosensing capabilities to the textured surface (e.g., oxygen sensing). In some embodiments, a solid particle solution having a range of particle sizes can be prepared by dissolving a UV curable solid in a solvent to form solid particle solution. The solution can be exposed to UV light of varying intensity to obtain a plurality of solid particles having a range of particle sizes suspended in the solvent.

### Example 6

### Adding Non-Solvent to the Solid Solution to Introduce Particles

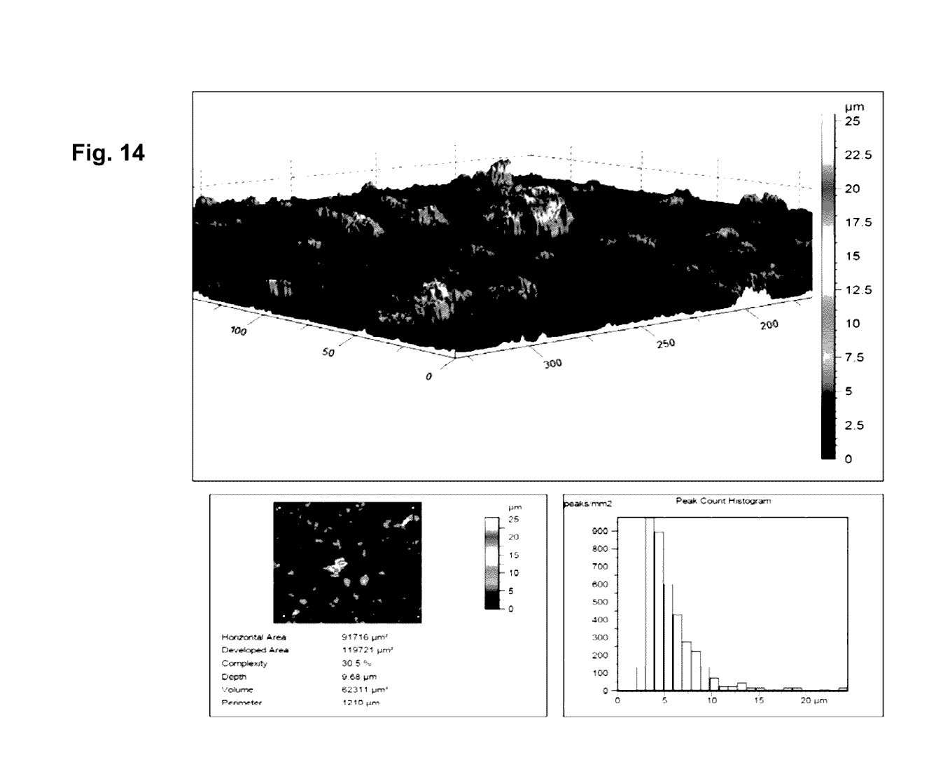

Solvent/non-solvent combinations can be used to produce solid particle suspensions or colloidal distributions which self-assemble into micro/nano-porous networks upon evaporation of the solvent mixture. Sonication can be used to break agglomerations yielding a tighter particle size distribution. For example, some polymers (e.g., isotactic polypropylene) can be dissolved completely in a high boiling compatible solvent (e.g, Xylene) at 2 grams/100 ml concentration followed by the addition of a non-solvent (e.g., 2-butanone) before the system gels up (e.g., the ratio of Xylene to 2-butanone is less than 3:2). The resulting coating may be superhydrophobic in nature and with a complexity of approximately 30.5% as shown in FIG. 14.

The embodiments have been particularly shown and described, but it will be understood that various changes in form and details may be made.

1. A method of forming a textured surface, comprising:
dissolving a solid in a solvent to form a solution, the solid having a concentration less than a first saturation concentration of the solid in the solvent at a first temperature and greater than a second saturation concentration of the solid in the solvent at a second temperature;
allowing the solution to cool to the second temperature to form a solid particle solution;
disposing the solid particle solution on a surface; and
allowing the solvent to evaporate to form the textured surface.

2. The method of claim 1, further comprising:
heating the solvent to dissolve the solid in the solvent.

3. The method of claim 1, wherein the second temperature is room temperature.

4. The method of claim 1, wherein the first temperature is substantially equal to the boiling point of the solvent.

5. The method of claim 1, wherein the solid particle solution includes an additive.

6. The method of claim 5, wherein the additive is formulated to enhance spreading of the solid particle solution on the surface.

7. The method of claim 5, wherein the additive is formulated to enhance wetting of the solid particle solution on the surface.

8. The method of claim 5, wherein the additive is formulated to control evaporation of the solvent.

9. The method of claim 5, wherein the additive includes a silicone based sealant.

10. The method of claim 5, wherein the additive is a surfactant formulated to modify the surface chemistry of the textured surface.

11. The method of claim 5, wherein the additive is a surfactant formulated to enhance the wettability of an impregnating liquid to the textured surface.

12. The method of claim 5, wherein the additive is formulated to maintain the solid in at least one of a partially or a completely dissolved phase in the solution.

13. The method of claim 1, further comprising:
adding at least one of micro particles and nanoparticles to the solution to form a suspension.

14. The method of claim 1, further comprising:
transferring a liquid to the textured surface to form a liquid-impregnated surface.

15. A method of forming a textured surface, comprising:
combining a solid with a solvent;
dissolving the solid in the solvent to form a solution by heating the solvent to a first temperature, the solid having a concentration less than a first saturation concentration of the solid in the solvent at the first temperature and greater than a second saturation concentration of the solid in the solvent at a second temperature;
allowing the solution to cool to the second temperature to form a solid particle solution;
disposing the solid particle solution on a surface; and
allowing the solvent to evaporate to form the textured surface.

16. The method of claim 15, wherein the second temperature is room temperature.

17. The method of claim 15, further comprising:
controlling a cooling rate of the solution.

18. The method of claim 17, wherein the solid particle solution includes a plurality of solid particles and the cooling rate is configured to control a particle size distribution of the solid particles in the solvent.

19. The method of claim 15, further comprising:
heating the surface to evaporate the solvent.

20. The method of claim 15, further comprising:
transferring a liquid to the textured surface to form a liquid-impregnated surface.

21. A method of forming a textured surface, comprising:
heating a solvent to a first temperature;
dissolving a solid in the solvent to form a solution, the solid having a concentration less than a first saturation concentration of the solid in the solvent at the first temperature and greater than a second saturation concentration of the solid in the solvent at room temperature;
cooling the solution to the room temperature to form a solid particle solution;
disposing the solid particle solution on a surface; and
allowing the solvent to evaporate to form the textured surface.

22. The method of claim 21, further comprising:
storing the solution at a second temperature greater than room temperature, the second temperature sufficient to maintain the solid in at least one of a partially dissolved phase or a completely dissolved phase in the solution.

23. The method of claim 21, further comprising;
storing the solution at a second temperature at which the concentration is less than the first saturation concentration such that the solid is maintained in a completely dissolved phase in the solution.
